(19) United States
(12) Patent Application Publication
(10) Pub. No.: US 2015/0381430 A1
(43) Pub. Date: Dec. 31, 2015

(54) MANAGEMENT DEVICE AND INFORMATION PROCESSING SYSTEM

(71) Applicant: FUJITSU LIMITED, Kawasaki-shi (JP)

(72) Inventors: Yuki Deguchi, Numazu (JP); Hajime Hoashi, Numazu (JP); Kengo Hobo, Numazu (JP); Kazuhiro Watanabe, Kawasaki (JP)

(21) Appl. No.: 14/743,222

(22) Filed: Jun. 18, 2015

(30) Foreign Application Priority Data
Jun. 26, 2014 (JP) 2014-131466

(51) Int. Cl. H04L 12/24; H04L 12/26

(52) U.S. Cl. CPC H04L 41/12; H04L 43/062

(57) ABSTRACT

A management device includes a memory, and a processor coupled to the memory, configured to acquire an actual value of past traffic volume for each of logical interfaces set on physical interfaces included in the network devices, and store the acquired actual value in a storage unit, refer to the actual value of the traffic volume and, based on the actual value of the traffic volume, predict a future value of traffic volume for each of the logical interfaces, and add up, for each of the plurality of network devices, the predicted value of traffic volume for each of the logical interfaces to compute a predicted value of traffic volume of each of the network devices, and, based on the predicted value of traffic volume of each of the network devices, select one of the network devices to which a new network is to be assigned.

### CROSS-REFERENCE TO RELATED APPLICATION

This application is based upon and claims the benefit of priority of the prior Japanese Patent Application No. 2014-131466, filed on Jun. 26, 2014, the entire contents of which are incorporated herein by reference.

### FIELD

The embodiments discussed herein are related to techniques for automatically determining the assignment of a network device.

### BACKGROUND

As information processing systems become diversified, a system configuration in which a plurality of networks share a physical network environment is increasingly used. For example, this applies to a system in a cloud (multi-tenant) environment in which virtual machines (hereinafter abbreviated as “VMs”) running on information processing devices and networks used by the VMs are provided to multiple users. In such a system, a plurality of logical interfaces are mapped to one physical interface of a network device (for example, a router or the like).

Note that an example of the related art is as follows. In this technique, in a computer system for providing a service using VMs, a router acquires communication information for each flow, which is a set of a plurality of packets and is defined based on header information of packets passing through the router, and transmits the communication information to an analysis device. The analysis device analyzes the communication information and calculates, based on the analysis result, a packet drop occurrence probability representing the degree of risk that packet drop will occur in a router included in the communication route to the destination in the case where a VM is moved. Based on the packet drop occurrence probability, a management computer then decides a communication route to the destination of the VM.

Another example of the related art is as follows. In this technique, in a system, when arbitrary traffic statistical information exceeds a threshold a predetermined number of times within a fixed time period in the past, for example, it is determined that the quality has deteriorated. If this determination condition is not satisfied, the technique increases the number of pieces of past data for which it is automatically checked whether or not the threshold is exceeded. Then, if, for more than some proportion of the increased past data, the threshold is exceeded the predetermined number of times, it is also determined that deterioration in network quality has occurred. These techniques are disclosed in Japanese Laid-open Patent Publication No. 2013-150134 and Japanese Laid-open Patent Publication No. 2004-140717.

Here, in order to maintain network communication quality in a system environment in which a plurality of logical networks share a physical network environment, it is desirable to appropriately perform network setting. More particularly, it is desirable to appropriately assign a network device with which communication may be performed normally and continuously in years to come.

### SUMMARY

According to an aspect of the invention, a management device includes a memory, and a processor coupled to the memory, configured to acquire, from a plurality of network devices to be monitored, an actual value of past traffic volume for each of logical interfaces set on physical interfaces included in the network devices, and store the acquired actual value in a storage unit, refer to the actual value of the traffic volume stored in the storage unit and, based on the actual value of the traffic volume, predict a future value of traffic volume for each of the logical interfaces, and add up, for each of the plurality of network devices, the predicted value of traffic volume for each of the logical interfaces to compute a predicted value of traffic volume of each of the network devices, and, based on the predicted value of traffic volume of each of the network devices, select one of the network devices to which a new network is to be assigned.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram of the entire system in this embodiment;

FIG. 2 is a diagram illustrating access to a data group in a storage unit performed by a receiving unit, a monitoring unit, an analysis unit, a selection unit, and a setting unit, and communication with an administrator terminal and a router;

FIG. 3 illustrates a diagram of the outline (image) of an example of the relationship among an approximate expression of an analysis unit time period M based on an actual value for each regular monitoring time period K of the traffic volume for each router, a prediction formula W_{R}, a tolerance L, and a predicted time period R;

FIG. 4 is a diagram illustrating an example of basic definition information;

FIG. 5 is a diagram illustrating an example of a device information table;

FIG. 6 is a diagram illustrating an example of a VM creation information table;

FIG. 7 is a diagram illustrating an example of a network definition information table;

FIG. 8 is a diagram illustrating an example of a traffic information table;

FIG. 9 is a diagram illustrating an example of an evaluation information table;

FIG. 10 is a diagram illustrating an example of a logical network configuration in a system of this embodiment;

FIG. 11 is a flowchart illustrating an example of a process of receiving a basic definition information registration request, the process being performed by the receiving unit;

FIG. 12 is a flowchart illustrating an example of a process of receiving a monitoring target registration request, the process being performed by the receiving unit;

FIG. 13 is a flowchart illustrating an example of a process of receiving a network definition information registration request, the process being performed by the receiving unit;

FIG. 14 is a flowchart illustrating an example of a process of receiving a VM creation information registration request, the process being performed by the receiving unit;

FIG. 15 is a flowchart illustrating an example of a traffic monitoring process performed by the monitoring unit;

FIG. 16 is a flowchart illustrating an example of a traffic analysis process performed by the analysis unit;

FIG. 17 is a flowchart illustrating an example of a first pattern process in the traffic analysis process performed by the analysis unit;

FIG. 18 is a flowchart illustrating an example of a second pattern process in the traffic analysis process performed by the analysis unit;

FIG. 19 is a flowchart illustrating an example of a third pattern process in the traffic analysis process performed by the analysis unit;

FIG. 20 is a flowchart illustrating an example of a router selection process performed by the selection unit;

FIG. 21 is a flowchart illustrating an example of the router selection process performed by the selection unit;

FIG. 22 is a flowchart illustrating an example of a network or the like selection process performed by the setting unit;

FIG. 23 is a diagram regarding an example of classification by evaluation type in accordance with changes in traffic volume;

FIG. 24 is a diagram regarding an example of prediction of changes in traffic volume in an evaluation type A;

FIG. 25 is a diagram regarding an example of prediction of changes in traffic volume in an evaluation type B;

FIG. 26 is a diagram regarding an example of prediction of changes in traffic volume in an evaluation type C;

FIG. 27 is a diagram regarding an example of data indicating an approximate expression based on traffic volume;

FIG. 28 is a diagram regarding an example of data indicating an approximate expression based on traffic volume;

FIG. 29 is a diagram regarding an example of data indicating a predicted value of traffic volume;

FIG. 30 is a diagram illustrating an example of basic definition information;

FIG. 31 is a diagram illustrating an example of an evaluation information table;

FIG. 32 is a flowchart illustrating an example of a traffic analysis process performed by the analysis unit;

FIG. 33 is a flowchart illustrating an example of the traffic analysis process performed by the analysis unit;

FIG. 34 is a flowchart illustrating an example of a router selection process performed by the selection unit; and

FIG. 35 illustrates an example of a hardware configuration of a management server in this embodiment.

### DESCRIPTION OF EMBODIMENTS

### Outline of Embodiments

In these embodiments, in a system environment in which a plurality of logical networks (for example, virtual local area networks (VLANs)) share a physical network environment, techniques for achieving appropriate assignment of network devices to newly set logical networks will be described. In particular, in the embodiments, changes in the traffic volume in the future are predicted based on traffic information in the past in each network device included in the system. The traffic volume is the volume of packets passing through a network device.

Here, in the embodiments, a management server that performs assignment of a network device predicts changes in the traffic volume in each network device not on the basis of a physical interface but on the basis of each of logical interfaces corresponding to the physical interface. Note that a logical interface is a sub-interface set for each logical network that uses a physical interface. Thus, changes in traffic volume in the future are predicted more accurately.

In particular, in the embodiments, a management server, when predicting changes in the traffic volume for each logical interface, analyzes changes in the traffic volume in the past and, according to the change pattern, classifies the changes into a plurality of evaluation types. Then, using a prediction method suitable for each evaluation type, the management server predicts future changes in the traffic volume for the logical interface. Here, an example of an evaluation type is described. For example, in a system in a cloud (multi-tenant) environment in which VMs are run and services are provided to a plurality of customers, each VM executes a respective piece of customer business processing. In such customer business processing, similar processing is sometimes repeated in a certain operating cycle (for example, every day, or the like). In this case, the traffic volume in a VLAN used by a VM in question is often represented as repetitions of similar changes in this cycle. To deal with such a case, a management server identifies, as one evaluation type, the case where changes in the traffic volume in the past in an analysis unit time period in question are similar to those in the previous analysis unit time period having the same duration as that of the analysis unit period in question. For the case of this evaluation type, the management server predicts that similar changes in traffic volume will be repeated in the future. In this way, the prediction accuracy is further improved. Other evaluation types will be described in detail in the description of embodiments.

Additionally, the management server, when predicting traffic volume, regards a prediction formula with which the risk of increasing the traffic volume is largest, as a prediction formula representing changes in traffic volume for a logical interface to be added. Thus, a logical interface may be assigned more safely.

### First Embodiment

### Overall System Configuration

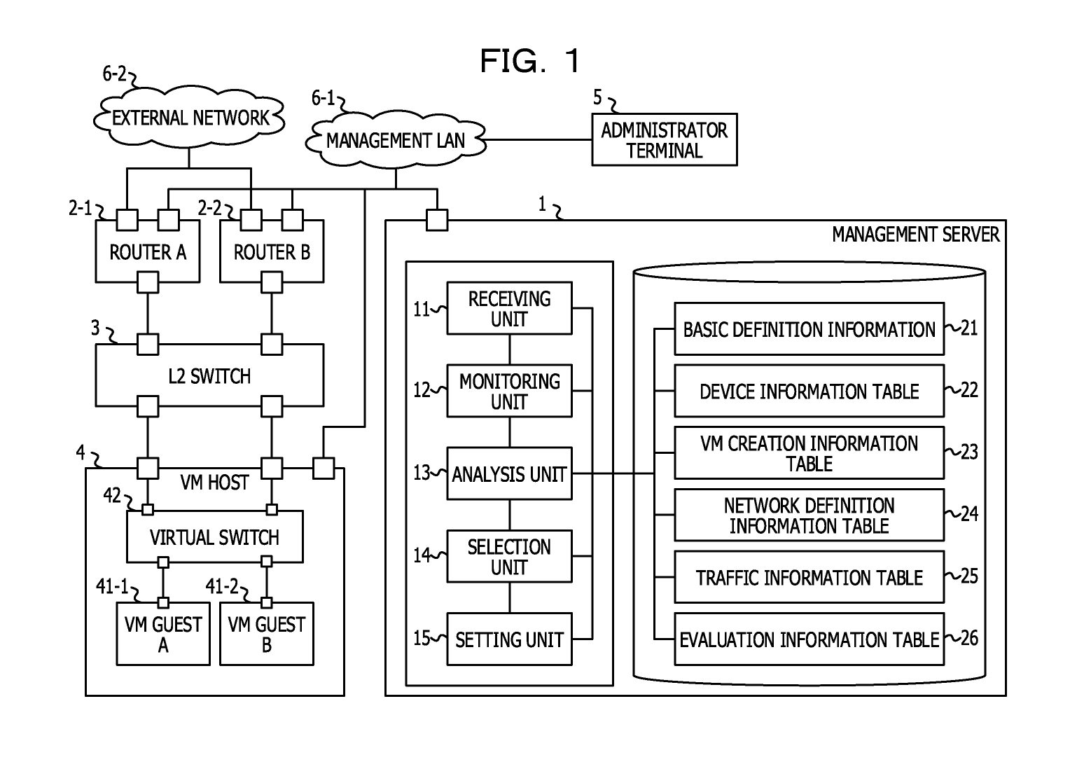

FIG. 1 illustrates an example of an overall configuration of a system and a functional configuration of each server in this embodiment.

This system includes a management server 1, a router A 2-1 and a router B 2-2, a layer 2 (L2) switch 3, a VM host 4, and an administrator terminal 5. The management server 1, the router A 2-1 and the router B 2-2, the L2 switch 3, the VM host 4, and the administrator terminal 5 are communicatively coupled via a network. More specifically, the management server 1 is coupled to an administrator terminal 5, the router A 2-1 and the router B 2-2, and the VM host 4 via a management local area network (LAN) 6-1. The router A 2-1 and the router B 2-2 are coupled to an external network 6-2 (for example, a wide area network (WAN) or the like) connected to a customer system or the like (not illustrated).

The management server 1 is a computer for setting management and so forth of VM guests 41 and for setting management of a virtual local area network (VLAN) used by the VM guests 41. The management server 1 writes various types of management information to a storage unit in response to a request received from the management terminal 5. The management server 1 also monitors traffic by receiving traffic information indicating traffic volume for each logical interface from the router A 2-1 and the router B 2-2. Then, the management server 1 analyzes changes in the traffic volume for each logical interface in accordance with a traffic monitoring result. Moreover, when creating a new VM guest 41 in accordance with an instruction from the administrator terminal 5, the management server 1 selects a suitable router 2 to which a new VLAN used by the new VM guest 41 is to be assigned, in accordance with a traffic monitoring result. Then, the management server 1 sets a logical interface of a VLAN for the selected router 2 and transmits a request for VM creation to the VM host 4.

The router A 2-1 and the router B 2-2 are network devices that relay communication between the external network 6-2 and the L2 switch 3. The router A 2-1 and the router B 2-2 are coupled to the management server 1 via the management LAN 6-1. The router A 2-1 and the router B 2-2 have ports, which are physical interfaces connected to the management LAN 6-1 and the external network 6-2. Note that the port is an example of the physical interface. In response to a request from the management server 1, the router A 2-1 and the router B 2-2 transmit traffic information for each physical interface of the router A 2-1 and the router B 2-2 on the basis of a logical interface assigned to the physical interface.

The L2 switch 3 is a network device that relays communication between the router A 2-1 as well as the router B 2-2 and the VM host 4.

The VM host 4 is a computer provided with a virtual environment, and a VM guest A 41-1 and a VM guest B 41-2 run on a hypervisor. The VM host 4 is coupled to the management server 1 via the management LAN 6-1 and performs creation of the VM host 41, and the like, in accordance with an instruction from the management server 1. Each of the VM guest A 41-1 and the VM guest B 41-2 communicates through a VLAN with the external network 6-2 connected to a customer system. Each of VLANs used by VM guests is coupled via a virtual switch 42 created on the VM host 4 to the L2 switch 3.

The administrator terminal 5 is a computer used by the system administrator. The administrator terminal 5 transmits, in response to an input operation of the system administrator, an instruction for writing various types of information, an instruction for creating a VM, and the like to the management server 1.

Note that a system configuration illustrated in FIG. 1 is merely exemplary. For example, the numbers of components (for example, the number of routers 2, the numbers of VM hosts 4 and VM guests 41, and the like) are not limited to those illustrated in FIG. 1. Additionally, the connection arrangement using networks of components is not limited to that illustrated in FIG. 1. Furthermore, the network may be either a wired connection or a wireless connection.

In addition, in this embodiment, description is given assuming that the network device to which a VLAN is assigned is the router 2; however, the network device to which a VLAN is assigned is not limited to a router.

<Functional Configuration of Management Server>

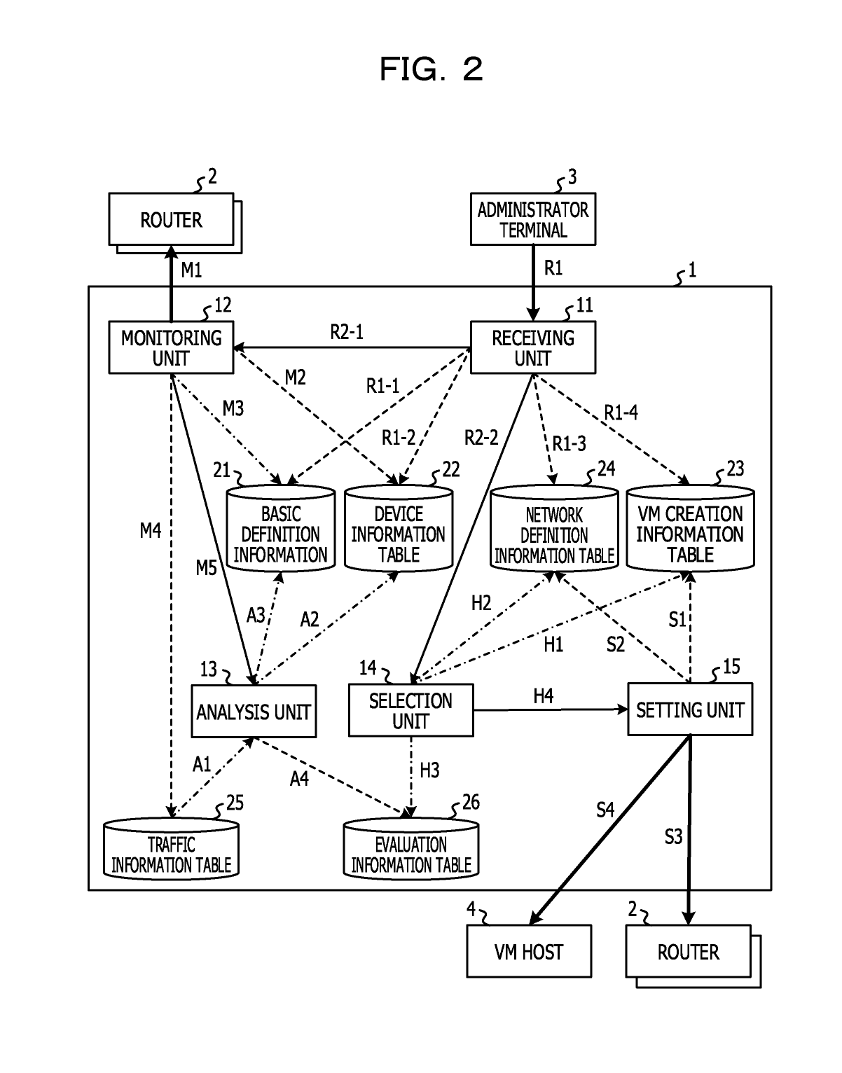

The management server 1, as illustrated in FIG. 1, includes a receiving unit 11, a monitoring unit 12, an analysis unit 13, a selection unit 14, and a setting unit 15 whose functions are implemented by executing a program installed in the management server 1. Additionally, basic definition information 21, a device information table 22, a VM creation information table 23, a network definition information table 24, a traffic information table 25, and an evaluation information table 26 are stored in the storage unit included in the management server 1. Additionally, FIG. 2 illustrates access to the data group mentioned above in the storage unit performed by the receiving unit 11, the monitoring unit 12, the analysis unit 13, the selection unit 14, and the setting unit 15, and communication with the routers 2 and the administrator terminal 5. Hereinafter, reference numerals indicated in square brackets correspond to reference numerals indicated in FIG. 2. Additionally, in FIG. 2, solid-line arrows indicate transmission of requests or the like between components. Additionally, broken-line arrows indicate data writing, and long-dashed short-dashed line arrows indicate data reference.

The receiving unit 11 receives a request from the administrator terminal 5 [R1] and performs processing according to the request. Specifically, the receiving unit 11, upon receipt of a request for registration of basic definition information, writes the basic definition information 21 to the storage unit [R1-1]. Additionally, upon receipt of a request for registration of device information of the router 2 to be monitored, the receiving unit 11 writes the device information to the device information table 22 [R1-2] and transmits, to the monitoring unit 12, a request to start a process of monitoring the router 2 to be monitored [R2-1]. Furthermore, upon receipt of a request for registration of network definition information, the receiving unit 11 writes the network definition information to the network definition information table 24 [R1-3]. Furthermore, upon receipt of a request for VM creation, the receiving unit 11 writes VM creation information to the VM creation information table 23 [R1-4] and transmits, to the selection unit 14, a request to start a process of selecting the router 2 for which a VLAN used by a newly created VM is to be set [R2-2]. Note that each type of information will be described in detail below.

The monitoring unit 12, in response to the request to start a process of monitoring the router 2 received from the receiving unit 11, monitors traffic in each of the router A 2-1 and the router B 2-2 for each logical interface [M1]. Specifically, the monitoring unit 12 receives information on a logical interface to be monitored from the router A 2-1 and the router B 2-2 and writes the information to the device information table 22 [M2]. Additionally, the monitoring unit 12 refers to the basic definition information 21 [M3], and, in each regular monitoring time period set in the basic definition information 21, receives traffic information of each logical interface from the router A 2-1 and the router B 2-2 and writes the traffic information to the traffic information table 25 [M4]. Furthermore, the monitoring unit 12 transmits, to the analysis unit 13, a request to start a process of analyzing traffic information [M5].

The analysis unit 13, in response to the request to start a process of analyzing traffic information received from the monitoring unit 12, refers to the traffic information table 25 [A1] and analyzes changes in traffic volume for each logical interface. More specifically, the analysis unit 13 refers to the device information table 22 [A2] and acquires information on a logical interface to be analyzed. The analysis unit 13 also refers to the basic definition information 21 [A3] and acquires an analysis unit time period M for traffic analysis (evaluation). Then, the analysis unit 13 sets up an approximate expression D₁ representing changes in traffic volume, based on the actual value of traffic volume in a period from the latest monitoring time until the start of the analysis unit time period M. The analysis unit 13 further sets up an approximate expression D₂, based on the actual value of traffic volume in a period from the start of the analysis unit time period M concerned until the start of the next analysis unit time period M. Note that a least squares approximation method, for example, may be used for obtaining such approximate expressions (hereinafter, this applies to all the cases in which an approximate expression is obtained.). Then, the analysis unit 13 classifies changes in traffic volume into a plurality of evaluation types, in accordance with the number of pieces of traffic information acquired from the traffic information table 25 and a comparison result between the approximate expression D₁ and the approximate expression D₂. Then, in accordance with the evaluation type, the analysis unit 13 specifies prediction formulas W_{A} to W_{C} representing changes in the future value of traffic volume predicted for each of logical interfaces (the future value being referred to as the “predicted value” hereinafter). Then, an analysis result including the evaluation type and prediction content is written to an evaluation information table 26 [A4].

In response to the request to start a process of selecting the router 2 for which a VLAN used by a new VM is to be set (that is, a new VLAN), the request being received from the receiving unit 11, the selection unit 14 performs the process of selecting the router 2 for which the new VLAN is to be set. Specifically, the selection unit 14 refers to the VM creation information [H1] and acquires information related to a network used by the VM guest 41 to be newly created. The selection unit 14 further refers to the network definition information table 24 [H2], sets up a linear equation where the slope is the largest value among the largest traffic increases per given time period in logical interfaces of all the routers, and specifies the linear equation as a prediction formula W_{N} representing changes in traffic volume of an additional network. The selection unit 14 further refers to the evaluation information table 26 [H3], sets up, for each router 2, a prediction formula W_{R} obtained by combining together the prediction formulas W_{A} to W_{C} for traffic volume in each logical interface, and combines the prediction formula W_{R} with a prediction formula W_{N} of a VLAN to be added, thereby specifying a prediction formula W_{R′} representing changes in the predicted value of traffic volume of each router 2 after the network is added. Then, the selection unit 14 computes, for each router 2, a predicted time period R taken until the traffic volume reaches a tolerance (a value obtained by totaling up values of bandwidths of physical interfaces and then multiplying the resulting sum by a safety factor) L set for each router 2. If there is a router whose predicted time period R is such that the traffic volume does not reach the tolerance L within a given time (for example, the analysis unit time period M), the selection unit 14 selects this router 2. If the router 2 that satisfies such a condition is not present, then the selection unit 14 selects the router 2 whose predicted time period R is longer. Then, the selection unit 14 transmits a request for VM creation and network setting to the setting unit 15 [H4].

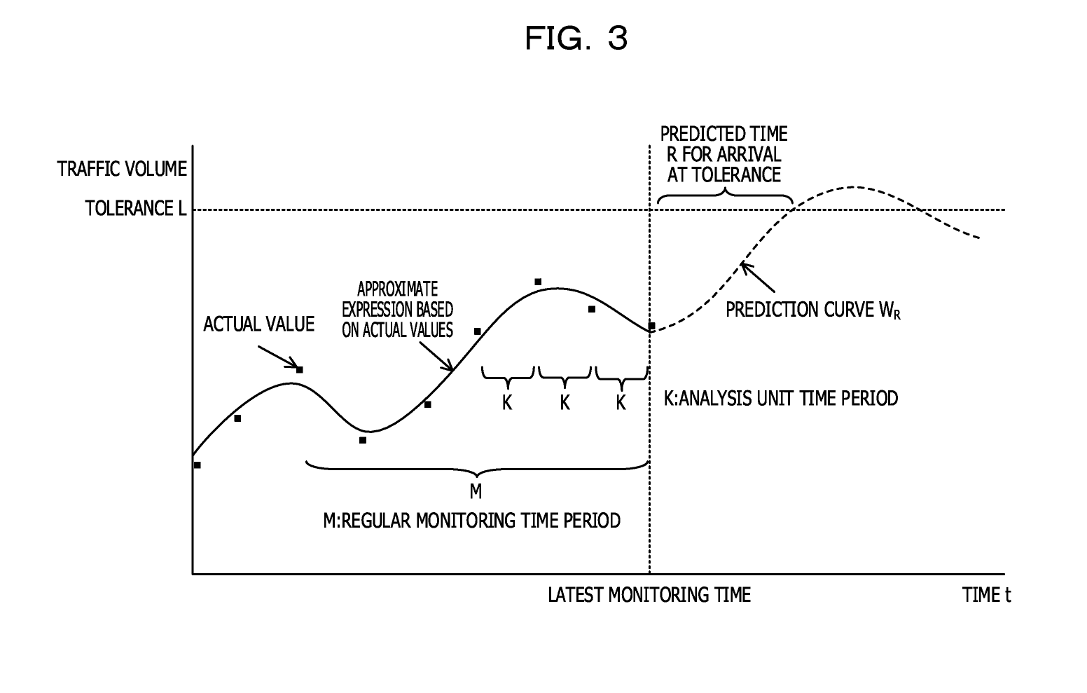

Note that FIG. 3 illustrates the outline (image) of an example of the relationship among an approximate expression of the analysis unit time period M based on an actual value in each regular monitoring time period K of the traffic volume of each router 2 mentioned above, the prediction formula W_{R} specified based on the approximate expression, the tolerance L, and the predicted time period R. In the graph illustrated in FIG. 3, a portion representing an approximate expression based on actual values of traffic volume is indicated by a solid line, and a portion representing the prediction formula W_{R} is indicated by a broken line. Note that, in this graph, a time period taken until the predicted volume of traffic computed using the prediction formula W_{R} exceeds the tolerance L is illustrated as the predicted time period R. In selecting the router 2, as described above, the router 2 is selected based on the predicted time period R taken until the predicted volume of traffic computed using the prediction formula W_{R′}, in which the prediction formula W_{N} of a VLAN to be added is included, exceeds the tolerance L.

The setting unit 15 performs various types of setting in response to the request for VM creation and network setting received from the selection unit 14. Specifically, the setting unit 15 refers to the VM creation information [S1] and acquires information on a network used by the VM guest 41 to be newly set, and then refers to a network setting information table [S2] and acquires setting information for a network. Then, the setting unit 15 performs processing such as network setting for the router 2 [S3] and transmission of a VM creation request to the VM host 4 [S4].

<Details of Data Configuration>

Next, data stored in the storage unit of the management server 1 will be described.

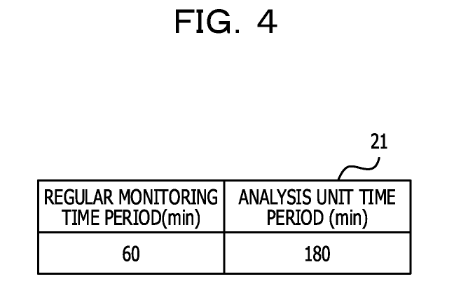

The basic definition information 21, being basic information used for collection of traffic information and traffic analysis, includes the regular monitoring time period (minute) and the analysis unit time period (minute) for traffic evaluation as depicted in FIG. 4.

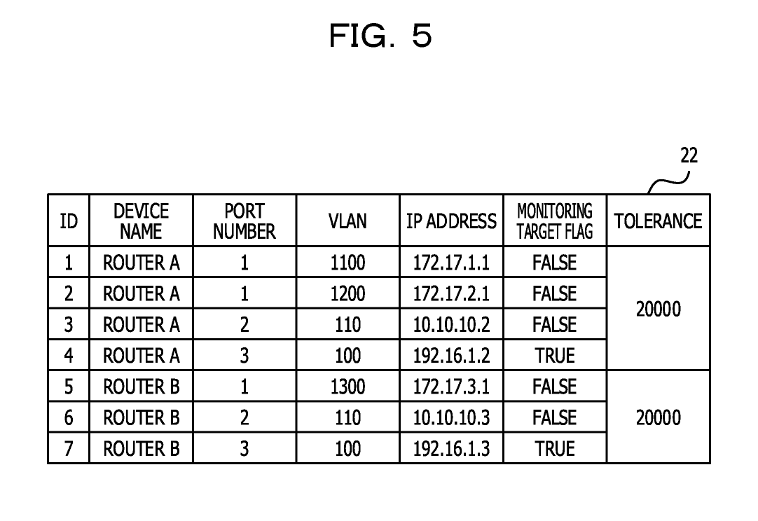

The device information table 22 is a table in which information on the router 2 to be monitored by the management server 1, that is, an object to which a new VLAN is to be assigned, is stored. The device information table 22, as depicted in FIG. 5, includes items of a record identifier (ID), a device name for identifying the router 2, a port number identifying a port that is a physical interface, a VLAN identifier identifying a VLAN, an Internet protocol (IP) address of a logical interface used by the VLAN, a monitoring target flag indicating whether or not the VLAN in question is one used for management, and a tolerance for traffic volume in the router 2. Note that, as depicted in records of the device information table 22, there are some cases in which IP addresses of logical interfaces used by a plurality of VLANs are assigned to one port number indicating the same physical interface.

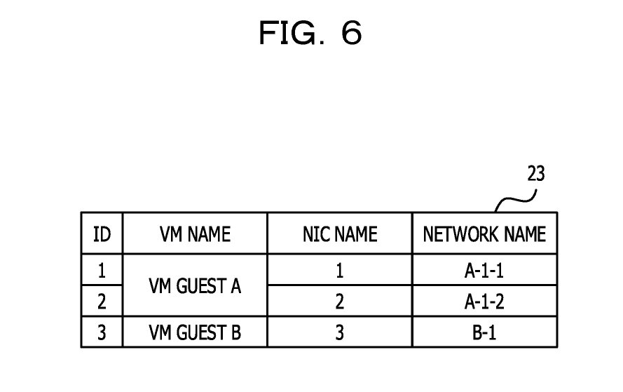

The VM creation information table 23 is a table in which information on the VM guest 41 created in the VM host 4 is stored. The VM creation information table 23, as depicted in FIG. 6, includes items of a record ID, a VM name identifying the VM guest 41, a network interface card (NIC) name identifying an NIC that connects the guest 41 to a VLAN, and a network name identifying a network (VLAN).

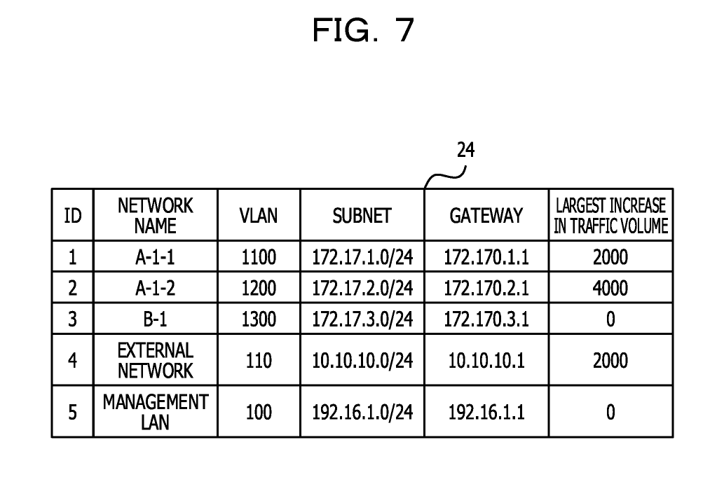

The network definition information table 24 is a table in which definition information on setting of networks (VLANs) is stored. The network definition information table 24, as depicted in FIG. 7, includes items of a record ID, a network name, a VLAN identifier, a subnet and a gateway in a logical interface used by a network (VLAN) in question, and the largest traffic increase in the regular monitoring time period K in the network (VLAN) in question.

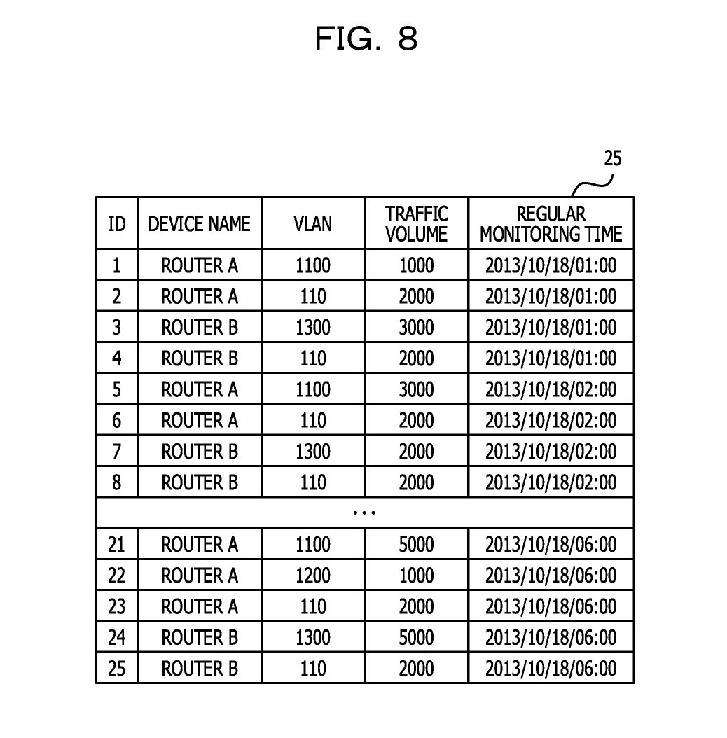

The traffic information table 25 is a table in which traffic information collected from the router 2 is stored. The traffic information table 25, as illustrated in FIG. 8, includes items of a record ID, a device name, a VLAB identifier, traffic volume, and a regular monitoring time at which the traffic volume is acquired.

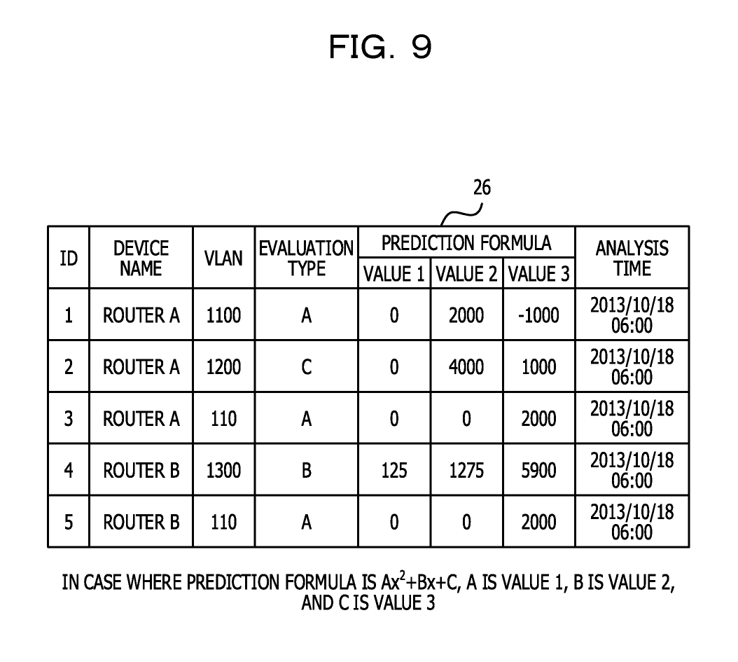

The evaluation information table 26 is a table in which results of analysis of traffic information performed by the analysis unit 13 are stored. The evaluation information table 26, as depicted in FIG. 9, includes items of a record ID, a device name, a VLAN identifier, an evaluation type, a value 1, a value 2, and a value 3 representing coefficients or the like of a prediction formula, and an analysis time at which an analysis result in question is identified. Note that, in a data specific example depicted in this embodiment, for the sake of simplification, it is assumed that the prediction formula is a quadratic expression Y=Ax²+Bx+C, and the value 1, the value 2, and the value 3 of the evaluation information table 26 are values corresponding to A, B, and C of this quadratic expression, respectively.

<Logical Network Configuration>

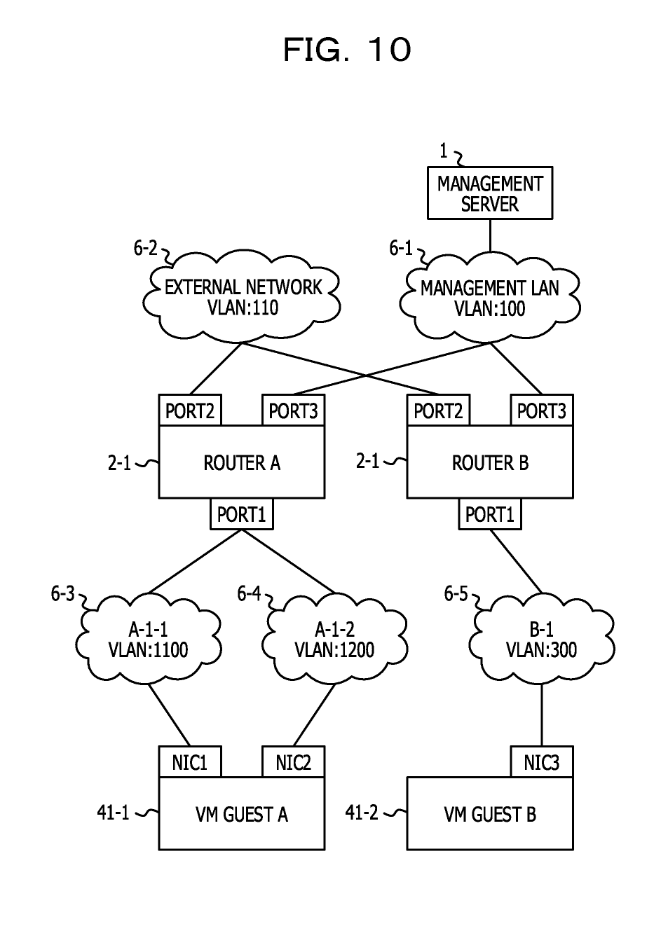

Here, the logical network configuration in a system of this embodiment will be described with reference to FIG. 10. The logical network configuration is also represented by data of the device information table 22, VM creation information table 23, and network definition information table 24 described above.

The management server 1 is connected via the management LAN 6-1 (VLAN: 100) to a port 3 of the router A 2-1 and a port 3 of the router B 2-2. Using the management LAN 6-1, the management server 1 performs traffic monitoring, network setting, and the like of the router A 2-1 and the router B 2-2 mentioned above.

A port 2 of the router A 2-1 and the port 3 of the router B 2-2 are connected to the external network 6-2 (VLAN: 110).

A port 1 of the router A 2-1 is connected to the NIC 1 of the VM guest A 41-1 through a network A-1-1 (VLAN: 1100). The port 1 of the router A 2-1 is further connected to an NIC 2 of the VM guest A 41-1 through a network A-1-2 (VLAN: 1200). That is, the port 1, being a physical interface of the router A 2-1, is used by two logical networks, and two logical interfaces are set for this port 1.

A port 1 of the router B 2-2 is connected to an NIC 3 of the VM guest B 41-2 through a network B-1 (VLAN: 1300).

<Process Description>

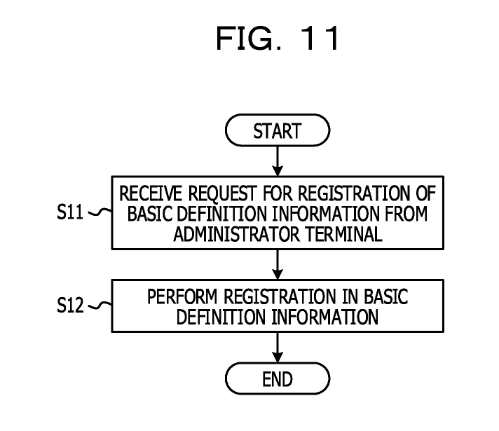

Details of processes performed by the receiving unit 11, the monitoring unit 12, the analysis unit 13, the selection unit 14, and the setting unit 15 will be described with reference to flowcharts illustrated in FIG. 11 to FIG. 22.

<Process Performed by Receiving Unit>

FIG. 11 illustrates a process of receiving a request for basic definition information registration, the process being performed by the receiving unit 11.

In step S11, the receiving unit 11 receives a request for registration of basic definition information from the administrator terminal 5. The registration request includes the regular monitoring time period K and the analysis unit time period M for traffic evaluation.

In step S12, the receiving unit 11 registers the received basic definition information in the basic definition information 21 of the storage unit.

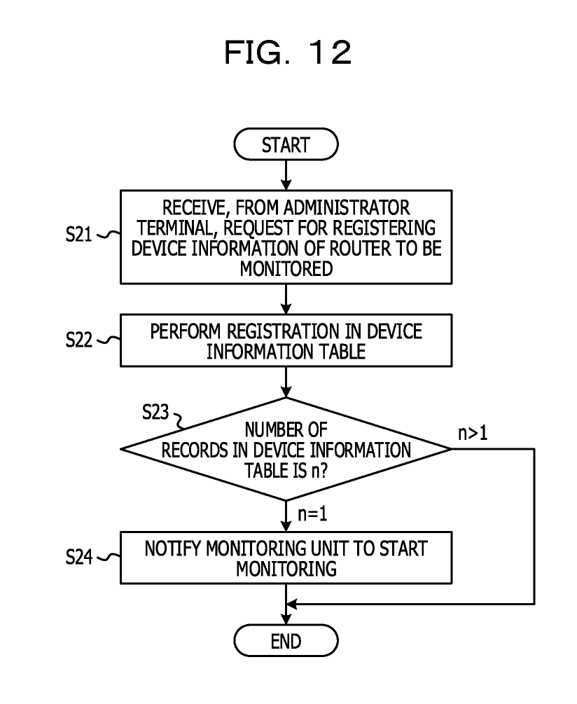

FIG. 12 illustrates a process of receiving a request for monitoring target registration, the process being performed by the receiving unit 11.

In step S21, the receiving unit 11 receives, from the administrator terminal 5, a request for registering device information on the router 2 to be monitored. The registration request includes a device name, which is device information, a port number, a VLAN identifier, an IP address, a monitoring target flag, and a tolerance.

In step S22, the receiving unit 11 registers the received device information in the device information table 22 of the storage unit.

In step S23, the receiving unit 11 checks the number of records of the device information registered in step S22 in the device information table 22. Then, when the number of records is one, that is, when the device information on a first one of the routers 2 to be monitored has been registered, the process proceeds to step S24. On the other hand, when the number of records is greater than one, that is, when the router 2 to be monitored is already present and monitoring has started, the process is completed.

In step S24, the receiving unit 11 notifies the monitoring unit 12 to start a monitoring device corresponding to the device name of the device information registered in step S22.

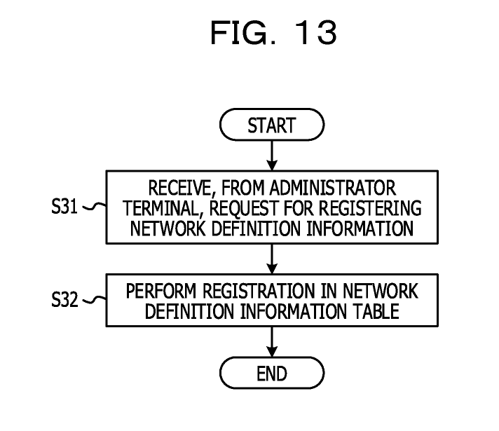

FIG. 13 illustrates a process of receiving a request for network definition information registration, the process being performed by the receiving unit 11.

In step S31, the receiving unit 11 receives, from the administrator terminal 5, a request for registering network definition information. The registration request includes a network name, which is network definition information, a VLAN identifier, the IP address of a subnet, the IP address of a gateway, and the largest traffic increase.

In step S32, the receiving unit 11 assigns an ID to the received network definition information and registers the information, together with the ID, in the network definition information table 24.

Note that the largest traffic increase is not received from the administrator terminal 5 but may be written to the network definition information table 24 based on a traffic volume monitoring result obtained by the monitoring unit 12.

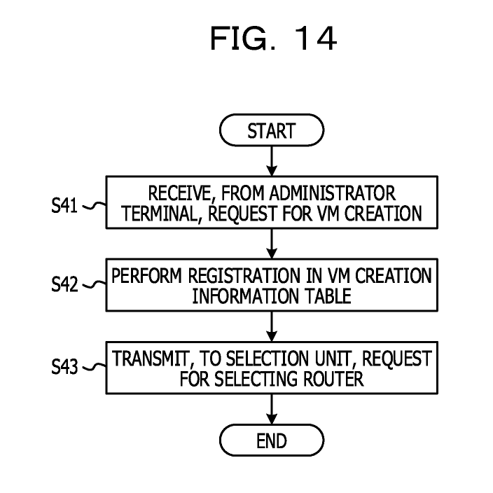

FIG. 14 illustrates a process of receiving a VM creation information registration request performed by the receiving unit 11.

In step S41, the receiving unit 11 receives, from the administrator terminal 5, a request for VM creation. This registration request includes a VM name, which is VM creation information, an NIC name, and a network name.

In step S42, the receiving unit 11 assigns an ID to the received VM creation information and registers the information, together with the ID, in the VM creation information table 23.

In step 43, the receiving unit 11 transmits, to the selection unit 14, a request for selecting the router 2 to which a network used by the created VM is to be assigned.

<Process Performed by Monitoring Unit>

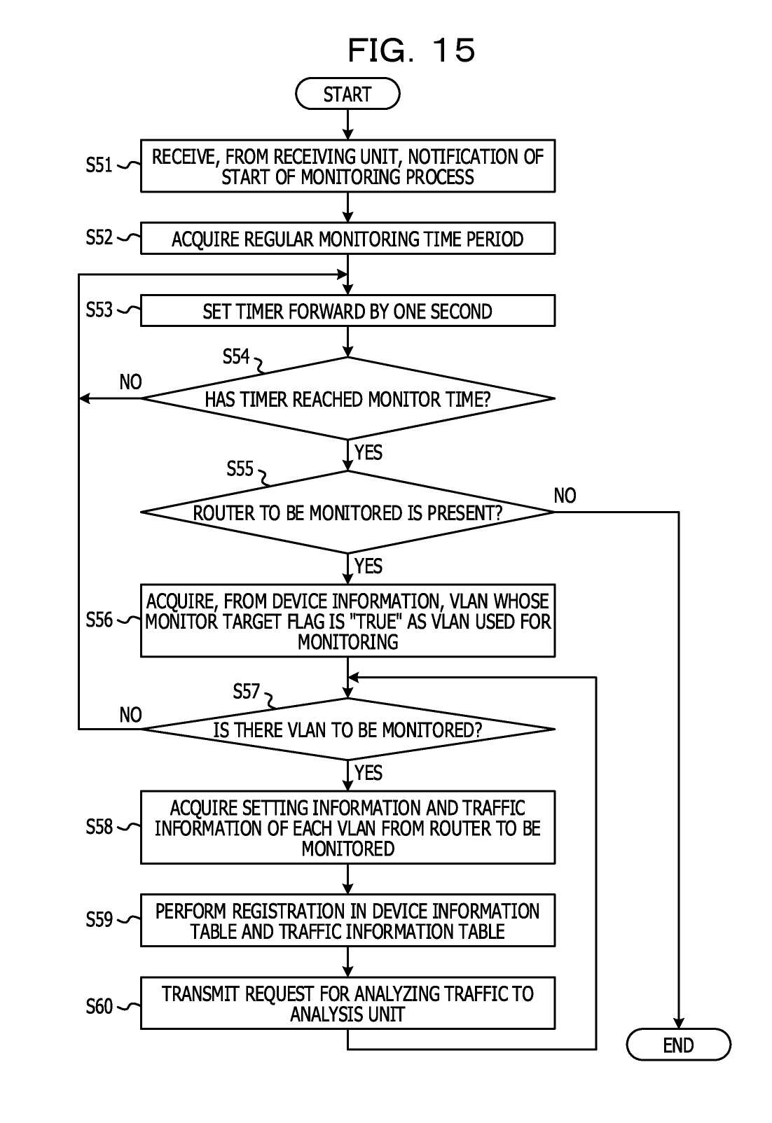

FIG. 15 illustrates a traffic monitoring process performed by the monitoring unit 12.

In step S51, the monitoring unit 12 receives, from the receiving unit 11, a notification of start of monitoring of the router 2 to be monitored.

In step S52, the monitoring unit 12 refers to the basic definition information 21 and decides upon the regular monitoring time period K.

In step S53, the monitoring unit 12 sets a timer forward by one second.

In step S54, the monitoring unit 12 determines whether or not the timer has reached a monitoring time. When the timer has reached (Yes), the monitoring unit 12 proceeds to step S55; when the timer has not reached (No), the monitoring unit 12 returns to step S53 and waits.

In step S55, the monitoring unit 12 refers to the device information table 22 and determines whether or not the router 2 to be monitored is present. Specifically, the monitoring unit 12 determines whether or not the router 2 whose monitoring target flag is “True” is present in the device information table 22. When the router 2 concerned is present (Yes), the monitoring unit 12 proceeds to S56; when the router 2 concerned is not present (No), the monitoring unit 12 completes the process.

In step S56, the monitoring unit 12 refers to the device information table 22 and acquires information related to a VLAN used for monitoring in the router 2 to be monitored, that is, a VLAN whose monitoring target flag is “True”.

In step S57, the monitoring unit 12 accesses the router 2 to be monitored using a VLAN used for monitoring and determines whether or not there is a VLAN to be monitored (a VLAN for which processing in step S58 to step S60 has not yet been performed). When there is a VLAN to be monitored (Yes), the monitoring unit 12 proceeds to S58; when there is no VLAN to be monitored, the monitoring unit 12 returns to step S53 and waits.

In step S58, the monitoring unit 12 acquires information related to a VLAN to be monitored from a device to be monitored. Specifically, the monitoring unit 12 acquires setting information of each VLAN to be monitored, that is, information such as a port number used by the VLAN, a VLAN identifier, and an IP address. The monitoring unit 12 also acquires traffic information in each VLAN to be monitored.

In step S59, the monitoring unit 12 registers information acquired in step S58 in the storage unit. Specifically, when setting information of a VLAN to be monitored has not yet been registered in the device information table 22, the monitoring unit 12 registers this information in the device information table 22. The monitoring unit 12 also registers traffic information of a VLAN to be monitored in the traffic information table 25. Specifically, the monitoring unit 12 acquires the traffic volume of a VLAN, that is, the traffic volume for a logical interface used by the VLAN, and registers, in the traffic information table 25, the traffic volume in association with a newly given ID, a device name, a VLAN identifier, and the current time.

In step S60, the monitoring unit 12 transmits, to the analysis unit 13, a request for a process of analyzing traffic in the router 2 to be monitored. Then, the monitoring unit 12 returns to step S57 and proceeds to a process of the next VLAN.

<Process Performed by Analysis Unit>

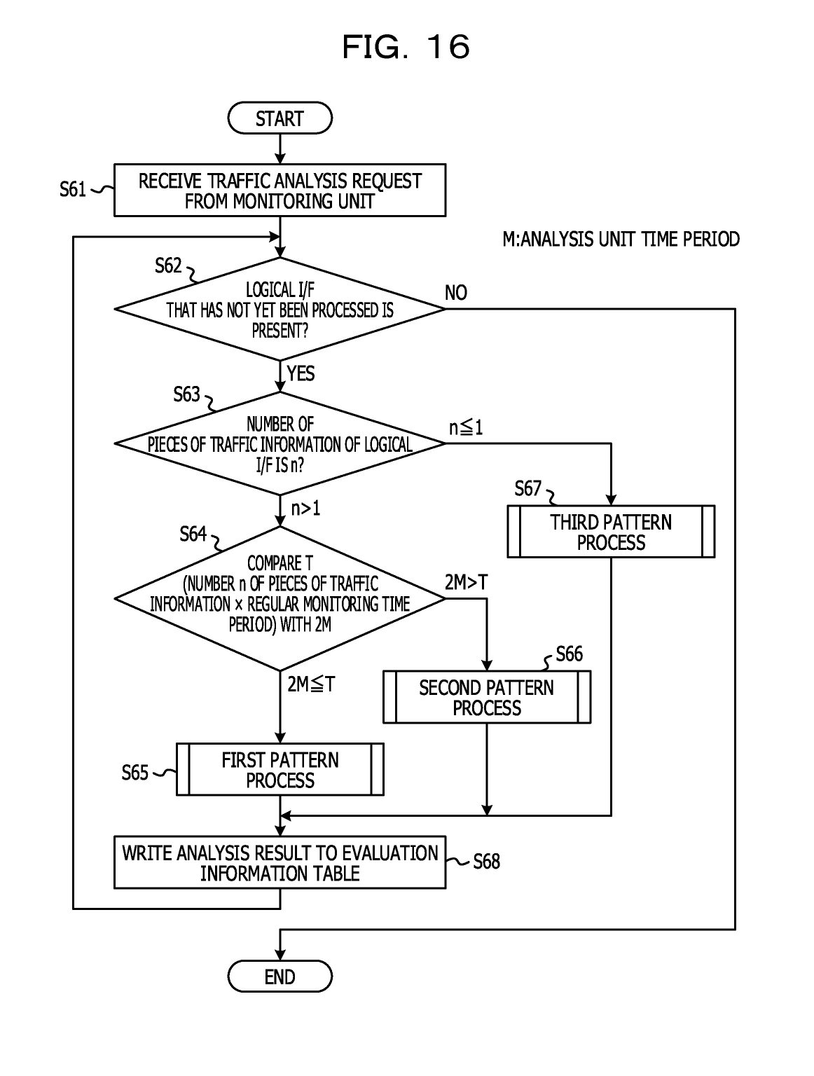

FIG. 16 illustrates a process of analyzing traffic in the router 2 to be monitored, the process being performed by the analysis unit 13.

In step S61, the analysis unit 13 receives, from the monitoring unit 12, a request to perform a process of analyzing traffic in the router 2 to be monitored.

In step S62, the analysis unit 13 refers to the device information table 22 and determines whether or not a logical interface that has not yet been processed is present. When the logical interface concerned is present (Yes), the analysis unit 13 proceeds to S63; when the logical interface concerned is not present (No), the analysis unit 13 completes the process.

In step S63, the analysis unit 13 refers to the device information table 22 and selects one logical interface to be analyzed. In other words, the analysis unit 13 selects one VLAN that uses one logical interface, from the device information table 22. Then, the analysis unit 13 refers to the traffic information table 25 and checks the number of pieces of traffic information of a logical interface used by this VLAN. When the number of pieces of traffic information is greater than one, that is, when it is possible to analyze traffic information (Yes), the analysis unit 13 proceeds to step S64. On the other hand, when the number of pieces of traffic information is less than or equal to one, that is, it is impossible to analyze traffic information (No), the analysis unit 13 proceeds to step S67.

In step S64, the analysis unit 13 compares a value (T) with a value (2M) twice the analysis unit time period M of the basic definition information 21. The value (T) is obtained by multiplying the number of pieces of traffic information of a logical interface used by a VLAN to be analyzed, which are registered in the traffic information table 25, by the regular monitoring time period K of the basic definition information 21. When T is greater than or equal to 2M, that is, when traffic information sufficient for analysis of traffic is obtained (Yes), the analysis unit 13 proceeds to step S65. When not, that is, when, although traffic analysis is possible with the obtained traffic information, traffic information sufficient for traffic analysis is not obtained (No), the analysis unit 13 proceeds to step S66.

In step S65, the analysis unit 13 performs a first pattern process (described in detail below), that is, a process performed when traffic information sufficient for traffic analysis is obtained.

In step S66, the analysis unit 13 performs a second pattern process (described in detail below), that is, a process performed when, although traffic analysis is possible with the obtained traffic information, traffic information sufficient for traffic analysis is not obtained.

In step S67, the analysis unit 13 performs a third pattern process (described in detail below), that is, traffic information with which analysis of traffic information is impossible.

In step S68, the analysis unit 13 registers, in the evaluation information table 26, a record indicating an analysis result for a VLAN that uses the logical interface to be analyzed. Specifically, the analysis unit 13 newly assigns a record ID and registers a record in which an evaluation type decided based on a pattern process of any of steps S65 to step S67, the coefficient of a specified prediction formula, and the current time are associated with this record ID, a device name, and a VLAN identifier. Subsequently, the analysis unit 13 returns to step S62 and proceeds to the next logical interface.

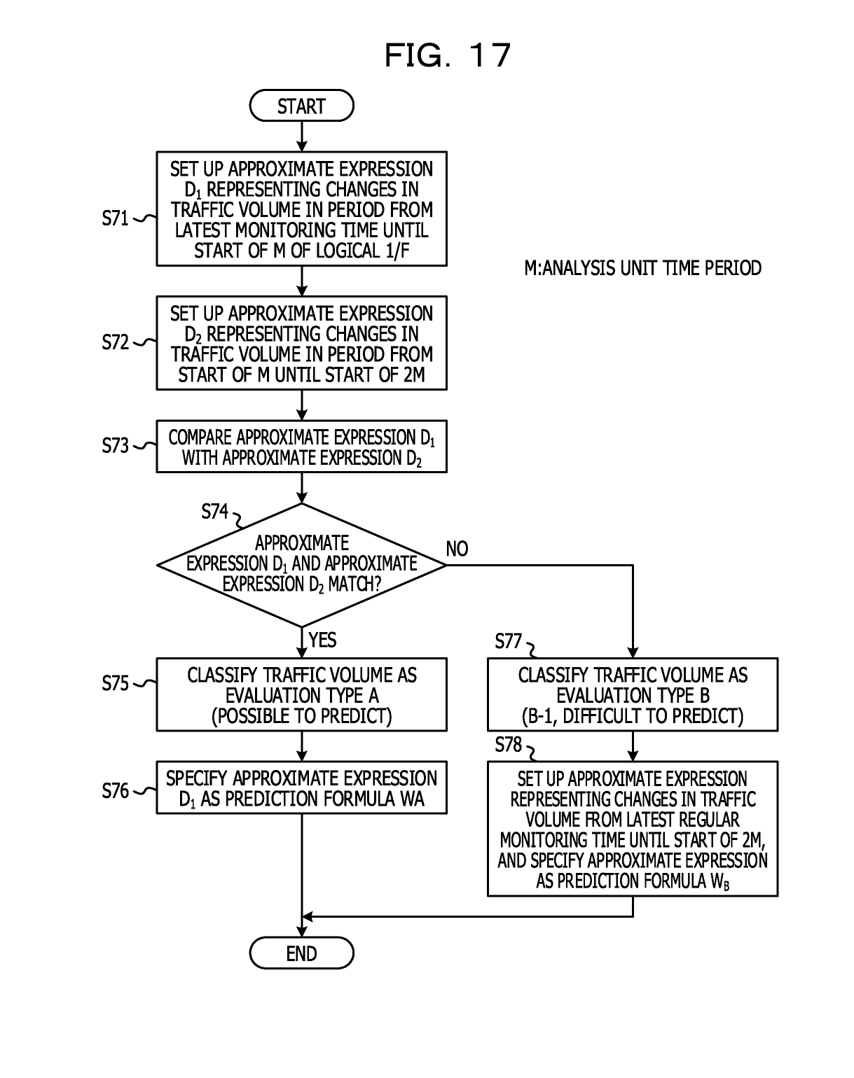

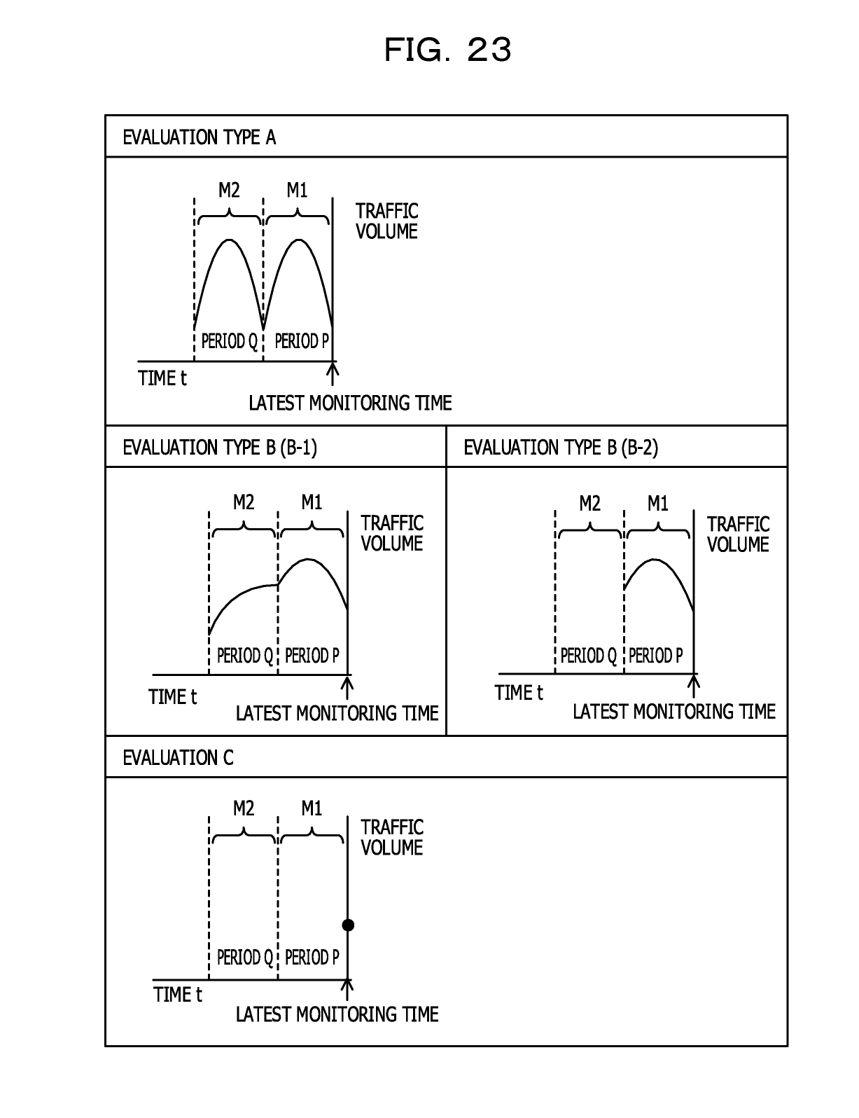

Here, the first pattern process, second pattern process, and third pattern process mentioned above will be described in detail with reference to FIG. 17 to FIG. 19. In each of the processes, a process of classification of evaluation types and predicting traffic volume in accordance with the evaluation types. FIG. 23 to FIG. 26 are appropriately referred to in the description of the processes.

FIG. 17 illustrates the first pattern process performed by the analysis unit 13.

In step S71, the analysis unit 13 acquires, from the traffic information table 25, traffic information of a period M1 from the latest regular monitoring time until the start of the analysis unit time period M, among traffic information of a VLAN that uses a logical interface to be analyzed. Then, the analysis unit 13 sets up an approximate expression D₁ representing changes in traffic volume in the period M1.

In step S72, the analysis unit 13 acquires, from the traffic information table 25, traffic information of a period M2 from the start of the analysis unit time period M until the start of the next analysis unit time period M among traffic information of a VLAN that uses a logical interface to be processed. Then, the analysis unit 13 sets up an approximate expression D₂ representing changes in traffic volume in the period M2.

In step S73, the analysis unit 13 compares the approximate expression D₁ obtained in step S71 with the approximate expression D₂ obtained in step S72.

In step S74, the analysis unit 13 determines whether or not the approximate expression D₁ and the approximate expression D₂ match. When both the approximate expressions match (Yes), the analysis unit 13 proceeds to step S75; when the approximate expressions do not match (No), the analysis unit 13 proceeds to step S77. Note that determining whether or not approximate expressions obtained based on actual values of traffic volume match is substantially synonymous with determining whether or not changes in the actual values of traffic volume coincide with or approximate each other.

In step S75, the analysis unit 13 classifies the traffic volume of a VLAN used by the logical interface to be analyzed as an “evaluation type A” of FIG. 23. That is, changes in traffic volume of the logical interface are repeated in cycles of the analysis unit time period M, and thus the traffic volume is classified as a category where it is possible to predict traffic volume.

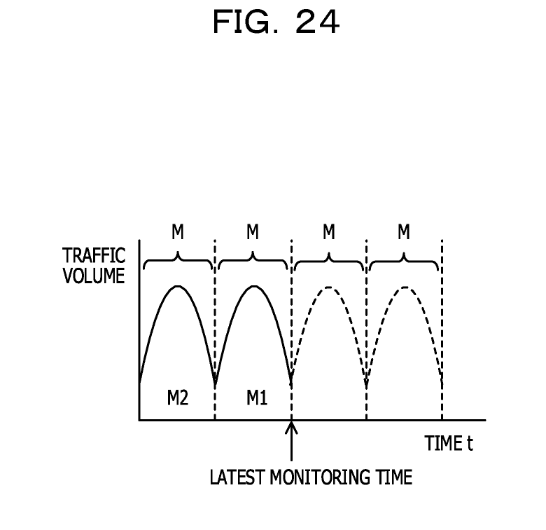

In step S76, the analysis unit 13, as illustrated in FIG. 24, specifies a prediction formula so that, in the future traffic volume for the logical interface concerned at and after the latest regular monitoring time, changes similar to those represented by the approximate expression concerned are repeated on the basis of the analysis unit time period M. Specifically, the analysis unit 13 specifies the approximate expression D₁ (or may use the approximate expression D₂) as the prediction formula W_{A} for changes in traffic volume in a period from the latest regular monitoring time until the end of the analysis unit time period M. That is, the prediction formula W_{A} of the evaluation type A is, for example, given below, where t is time.

W_{A}=f(t)=D₁(t mod M)

Note that the prediction formula concerned is similarly applicable to a period from the end of the analysis unit time period M, which is counted from the latest regular monitoring time, until the end of the next analysis unit time period M. Specifying a prediction formula representing changes in the predicted value of traffic volume is an example of a specific method for computing a predicted value. Furthermore, predicting that an approximate expression obtained based on actual values of traffic volume will match the prediction formula is substantially synonymous with predicting that changes in the actual value of traffic volume and changes in the predicted value of traffic volume coincide with or approximate each other. This applies to other prediction formulas.

In step S77, the analysis unit 13 classifies the traffic volume of a VLAN used by the logical interface being analyzed as an “evaluation type B (B-1)” of FIG. 23. That is, the approximate expression D₁ and the approximate expression D₂ do not match and changes in the traffic volume for the logical interface is irregular (unstable), and thus the traffic volume is classified into a category where it is difficult to predict traffic volume.

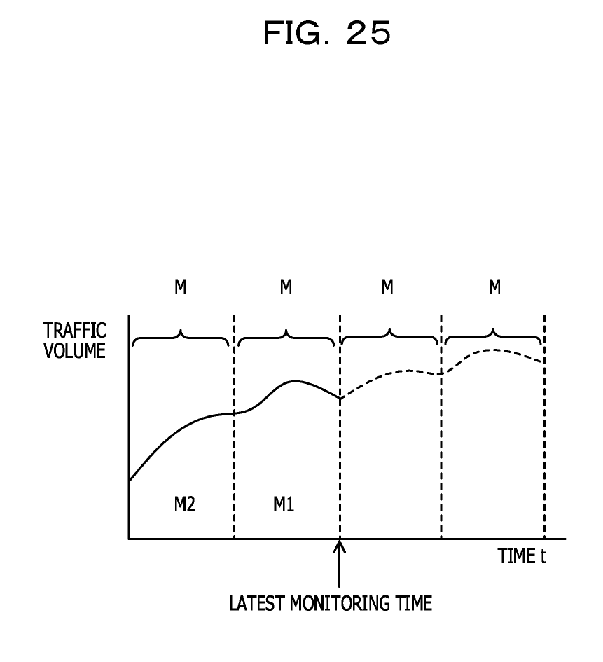

In step S78, the analysis unit 13, as illustrated in FIG. 25, specifies a prediction formula so that the future traffic volume of the logical interface concerned at and after the latest regular monitoring time is represented by an approximate expression obtained based on actual values of traffic volume over the entirety of the period M1 and the period M2. Specifically, the analysis unit 13 sets up an approximate expression D₃ representing changes in the traffic volume over the entirety of the period M1 and the period M2 (M1+M2). Then, the analysis unit 13 decides upon the approximate expression D₃ as a prediction formula W_{B} representing changes in traffic volume at and after the latest regular monitoring time. More specifically, the prediction formula W_{B} of the evaluation type B is, for example, given below, where t is time.

W_{B}=f(t)=atⁿ+btⁿ⁻¹+ . . . +z

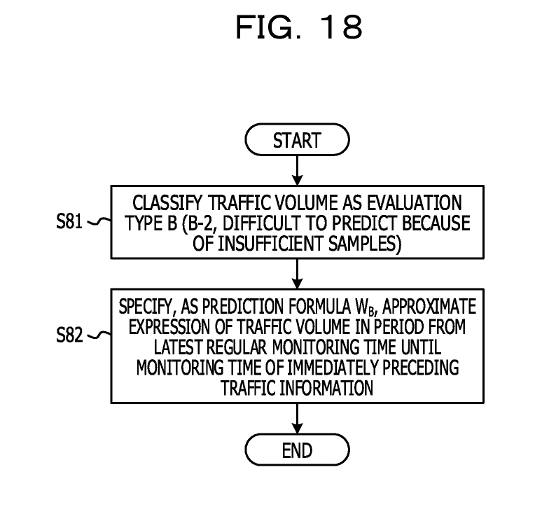

FIG. 18 illustrates the second pattern process performed by the analysis unit 13.

In step S81, the analysis unit 13 classifies the traffic of a VLAN used by the logical interface being processed, as an “evaluation type B (B-2)” of FIG. 23. That is, the traffic information (samples) is insufficient, and thus the traffic is classified into a category where it is difficult to predict traffic volume.

In step S82, the analysis unit 13 specifies the prediction formula W_{B} likewise for the “evaluation type B (B-1)” mentioned above based on the traffic volume within a range where traffic information is obtained, that is, within a period from the latest regular monitoring time until the regular monitoring time of the immediately preceding traffic information.

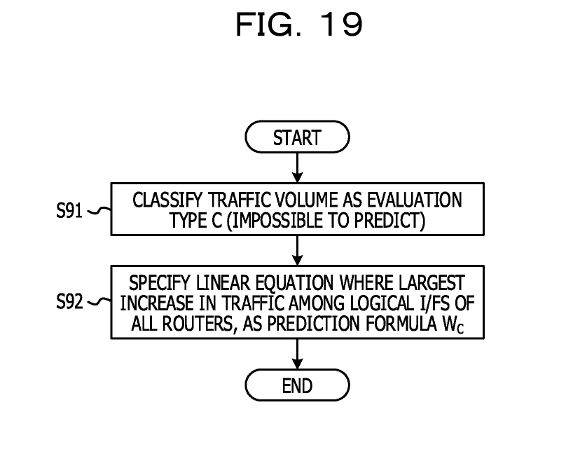

FIG. 19 illustrates the third pattern process performed by the analysis unit 13.

In step S91, the analysis unit 13 classifies the traffic of a VLAN used by the logical interface being processed, as an “evaluation type C” of FIG. 23. That is, changes in the traffic volume in the past are unclear, and thus the traffic is classified into a category where it is impossible to predict changes in traffic.

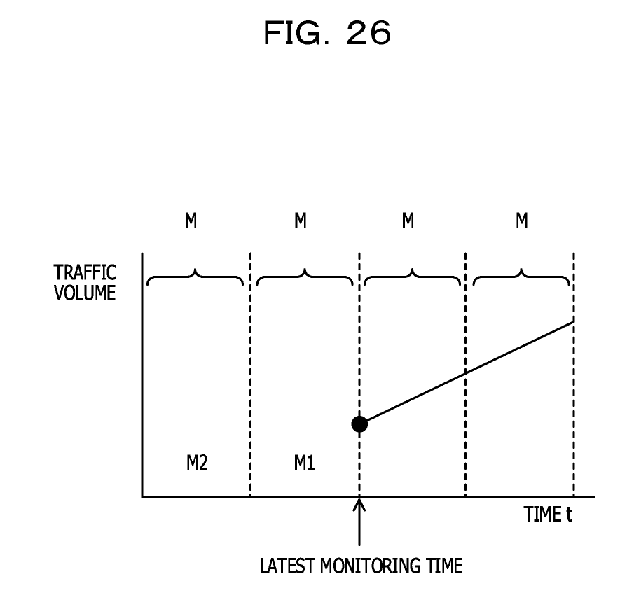

In step S92, the analysis unit 13, as illustrated in FIG. 26, specifies a prediction formula so that the future traffic volume of the logical interface concerned at and after the latest regular monitoring time is represented by a linear equation where the slope is the largest increase in traffic volume per the regular monitoring time period K in the logical interface concerned. Specifically, the analysis unit 13 refers to the network definition information table 24 and acquires the largest increase in the traffic volume in the VLAN concerned. Then, the analysis unit 13 sets up a linear equation where the largest increase concerned is the slope. Then, the analysis unit 13 specifies this linear equation as the prediction formula W_{C} for changes in the traffic volume at and after the latest regular monitoring time.

Note that the prediction formula W_{C} of the evaluation type C is, for example, given below, where S is the slope, p is the actual value of traffic volume at the latest monitoring time that is able to be acquired (0 is taken when the actual value is not able to be acquired), and t is time.

W_{C}f(t)=maxSt+p

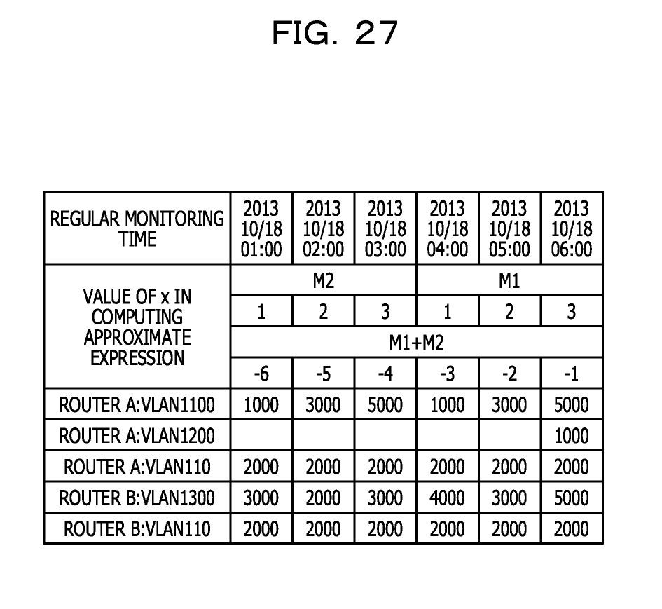

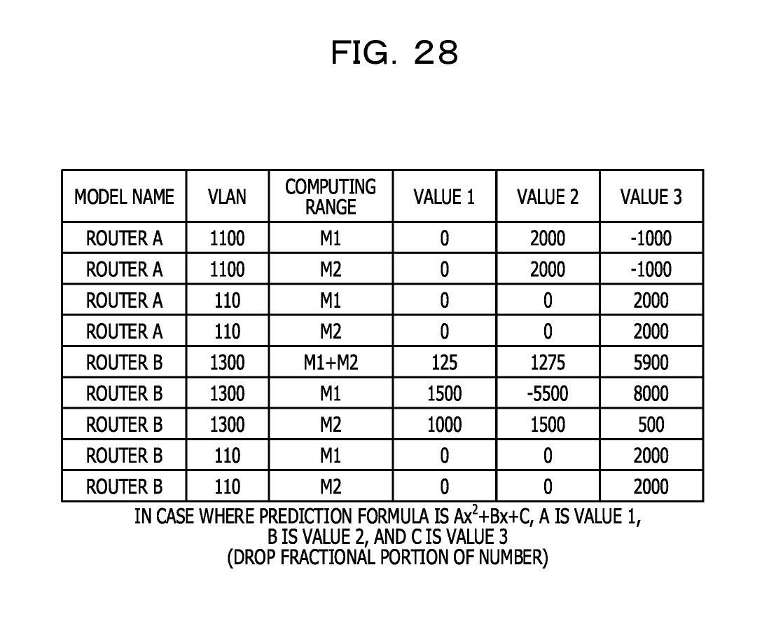

Here, the above processes performed by the analysis unit 13 will be described with reference to a data specific example of the evaluation information table 26 depicted in FIG. 9 and internal data (not illustrated in FIG. 1) in the case where an approximate expression is obtained based on changes in past traffic volume, depicted in FIG. 27 and FIG. 28.

FIG. 27 depicts details of traffic volume for logical interfaces of VLANs, including that not depicted in FIG. 8, for data of the traffic information table 25. Note that FIG. 27 further depicts the value of x (that is, a value corresponding to time t) used when, given that an approximate expression is Y=Ax²+Bx+C, the approximate expression D₁ of the period M1, the approximate expression D₂ of the period M2, and the approximate expression D₃ of the period M1+M2 are obtained. FIG. 28 depicts a data specific example where the approximate expression D₁, the approximate expression D₂, and, if desired, the approximate expression D₃ are obtained based on the traffic volume depicted in FIG. 27. The value 1, the value 2, and the value 3 in FIG. 28 are values corresponding to A, B, and C in the approximate expressions described above, respectively.

For example, focusing on the logical interfaces of a VLAN 1100 of the router A 2-1, as illustrated in FIG. 28, the approximate expression D₁ of the period M1 is the same as the approximate expression D₂ of the period M2. In this case, the analysis unit 13, in step S75, classifies the traffic volume as the evaluation type A. Then, the analysis unit 13 sets the approximate expression D₁ as the prediction formula W_{A} in the logical interfaces concerned, as depicted in the evaluation information table 26 of FIG. 9.

Focusing on the logical interfaces of a VLAN 1300 of the router B 2-2, as depicted in FIG. 28, the approximate expression D₁ of the period M1 differs from the approximate expression D₂ of the period M2. In this case, the analysis unit 13, in step S77, classifies the traffic volume as the evaluation type B. The analysis unit 13 further sets up the approximate expression D₃ of the period of M1+M2 as depicted in FIG. 28. Then, the analysis unit 13 sets the approximate expression D₃ as the prediction formula W_{B} in the logical interfaces concerned, as depicted in the evaluation information table 26 of FIG. 9.

Furthermore, for example, focusing on the logical interface of a VLAN 1200 of the router A 2-1, traffic information was acquired only once, as depicted in FIG. 27. In this case, the analysis unit 13, in step S91, classifies the traffic volume as the evaluation type C. The analysis unit 13 further acquires the largest increase (4000) of traffic volume for the VLAN concerned in the network definition information table 24 depicted in FIG. 7. Then, the analysis unit 13, as depicted in the evaluation information table 26 of FIG. 9, sets the linear equation where the largest traffic increase is the slope, as the prediction formula W_{C} in the logical interface concerned.

<Process Performed by Selection Unit>

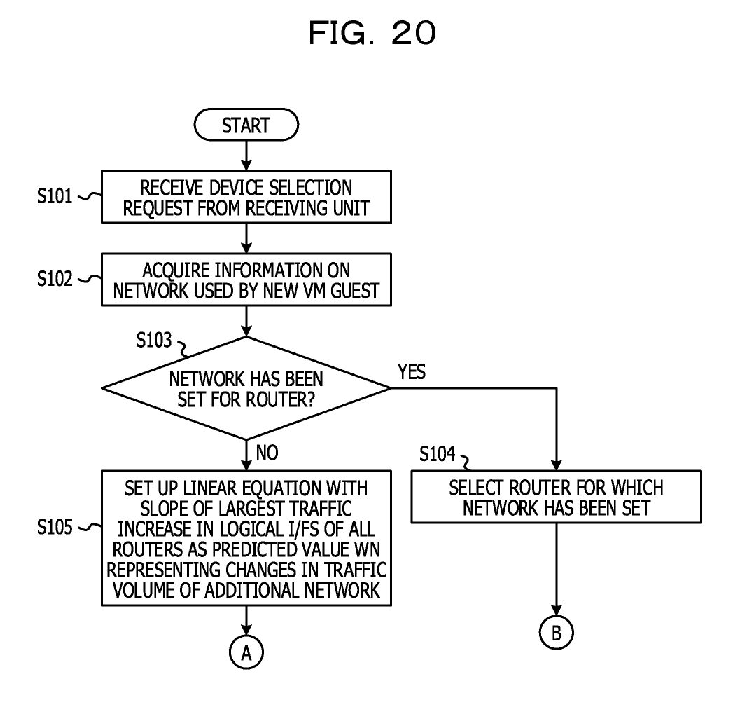

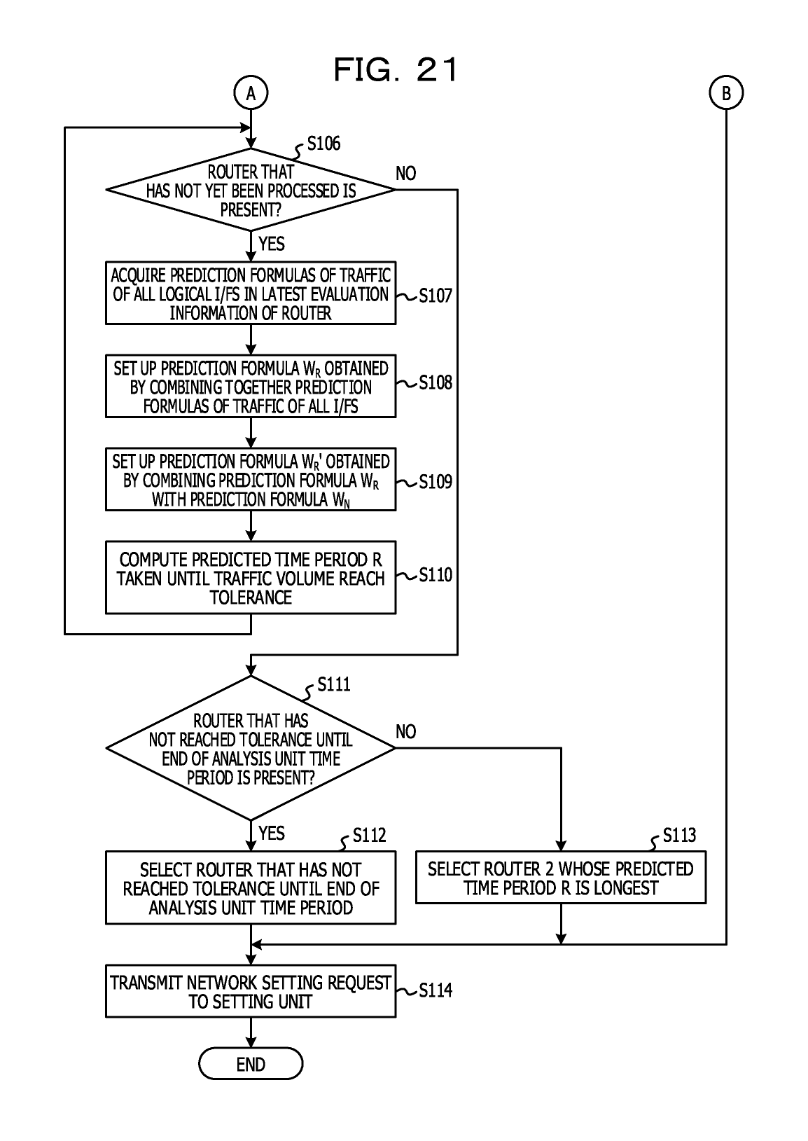

FIG. 20 to FIG. 21 illustrate a process of selecting the router 2 to which a new logical interface is to be assigned, the process being performed by the selection unit 14.

In step S101, the selection unit 14 receives, from the receiving unit 11, a request to select the router 2 to which a network used by the created VM is to be assigned.

In step S102, the selection unit 14 refers to VM creation information and acquires information related to a network used by the VM guest 41 to be newly created, that is, an NIC name and a network name.

In step S103, the selection unit 14 refers to the network definition information table 24 and the device information table 22 and determines whether or not a network used by the VM guest 41 to be newly created has already been set for some router 2. When the network has already been set (Yes), the selection unit 14 proceeds to step S104; when the network has not been set (No), the selection unit 14 proceeds to step S105.

In step S104, the selection unit 14 selects the router 2 for which a network used by the VM guest 41 to be newly created is set. Specifically, the selection unit 14 refers to the network definition information table 24 and the device information table 22 and, based on the IP address of a gateway corresponding to the name of a network used by the VM guest 41 to be newly created, identifies and selects the corresponding device name.

In step S105, the selection unit 14 refers to the network definition information table 24 and, using the largest value among the largest increases in traffic volume of all the VLANs, specifies a prediction formula of changes in traffic volume of a network used by the VM guest 41 to be newly created. Specifically, the selection unit 14 sets up a linear equation where the slope is the largest value among the largest increases in traffic volume for all the logical interfaces, for example. Then, the selection unit 14 specifies the linear equation as the prediction formula W_{N} of changes in traffic volume of a network used by the VM guest 41 to be newly created, that is, changes in traffic volume of a logical interface used by a newly added network.

In step S106, the selection unit 14 refers to the evaluation information table 26 and determines whether the router 2 that has not yet been processed is present. When the router 2 concerned is present (Yes), the selection unit 14 proceeds to step S107; when the router 2 concerned is not present (No), the selection unit 14 proceeds to step S111.

In step S107, the selection unit 14 selects one router 2 to be processed. Then, the selection unit 14 refers to the evaluation information table 26 and acquires the prediction formulas W_{A} to W_{C} of traffic of all the logical interfaces in the latest evaluation information of the router 2 to be processed.

In step S108, the selection unit 14 adds up predicted values of traffic volume of all the logical interfaces and specifies the prediction formula W_{R} for traffic volume of every router 2. Note that in the case where n logical interfaces are included in the router 2 and the numbers of logical interfaces of the evaluation type A, the evaluation type B, and the evaluation type C are nₐ, n_{b}, and n_{c}, respectively, (that is, n=nₐ+n_{b}+n_{c}), the prediction formula W_{R} is given as follows.

$${W}_{R} = {\sum }_{i = 0}^{{n}_{a}} {W}_{Ai} + {\sum }_{i = 0}^{{n}_{b}} {W}_{Bi} + {\sum }_{i = 0}^{{n}_{c}} {W}_{Ci}$$

In step S109, the selection unit 14 specifies a predication formula of traffic volume of the router 2 to be processed in the case where a logical interface used by a network used by the VM guest 41 to be newly created is set for the router 2 to be processed. Specifically, the selection unit 14 specifies the prediction formula W_{R′} obtained by combining the prediction formula W_{R} specified in step S108 with the prediction formula W_{N} for changes in traffic volume of a network used by the VM guest 41 to be newly created, the predication formula W_{N} being specified in step S105.

In step S110, the selection unit 14 computes the predicted time period R taken until the traffic volume exceeds the tolerance of a device to be processed in the case where a logical interface used by a network used by the VM guest 41 to be newly created is set for the router 2 to be processed. Specifically, using the prediction formula W_{R′} specified in step S109, the selection unit 14 computes traffic volume at each time at which the regular monitoring time period K has elapsed in a period from the current time until the end of the analysis unit time period M. Then, the selection unit 14 identifies a time at which the traffic volume reaches the tolerance L (exceeds the tolerance) of the router 2. Subsequently, the selection unit 14 returns to step S106 and proceeds to the process of the next router 2.

In step S111, the selection unit 14 determines whether or not the router 2 that has not reached the tolerance L until the end of the analysis unit time period M is present. When the router 2 concerned is present (Yes), the selection unit 14 proceeds to step S112; when the router 2 concerned is not present (No), the selection unit 14 proceeds to step S113.

In step S112, the selection unit 14 selects the router 2 that has not reached the tolerance L until the end of the analysis unit time period M, as the router 2 to which a new logical interface is to be assigned.

In step S113, the selection unit 14 selects the router 2 whose predicted time period R is longest, that is, the router 2 whose traffic volume exceeds the tolerance L of the router 2 last.

In step S114, the selection unit 14 transmits, to the setting unit 15, a request to perform a process of creating the VM guest 41 and setting a network used by the VM guest 41 for the selected device.

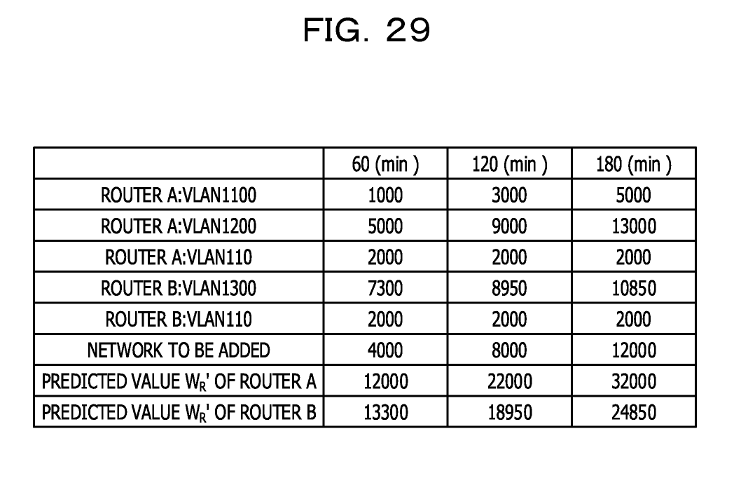

Here, the above process to be performed by the selection unit 14 is described with reference to a data specific example of predicted values of traffic volume depicted in FIG. 29. The data specific example concerned is a specific example in the case where the content of the prediction formula W_{R} in each of the logical interfaces is represented in the evaluation information table 26 depicted in FIG. 9.

Here, the prediction formula W_{N} of an additional network specified in step S105 by the selection unit 14 is a linear equation with a slope of 4000, which is the largest value among the largest increases in traffic volume of the network definition information table 24 depicted in FIG. 7. That is, the prediction formula W_{N} is a linear equation of Y=4000x. Note that x is a value corresponding to time t. Specifically, the regular monitoring time period K is 60 minutes, and therefore x is one after 60 minutes have elapsed, is two after 120 minutes have elapsed, and is three after 180 minutes have elapsed.

Then, computing predicted values of traffic volume of each router 2 using the prediction formula W_{R′} gives values as depicted in FIG. 29. Note that predicted values of traffic volume in each logical interface are also represented in FIG. 29. Here, as depicted in the device information table 22 of FIG. 5, both the tolerances L of the router A 2-1 and the router B 2-2 are 20000. Then, in comparison of the predicted values of traffic volume depicted in FIG. 29 of the router A 2-1 and the router B 2-2 with the tolerances L, the predicted value of traffic volume in the router A 2-1 exceeds the tolerance L after 120 minutes have elapsed, and the predicted value of traffic volume in the router B 2-2 exceeds the tolerance L after 180 minutes have elapsed. That is, the predicted time period R of the router A 2-1 is 120 minutes, and the predicted time period R of the router B 2-2 is 180 minutes. For this reason, the selection unit 14 selects the router B 2-2 in step S113.

<Process Performed by Setting Unit>

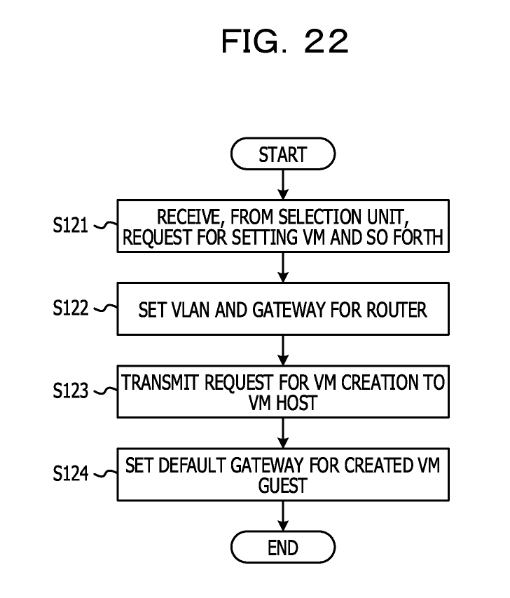

FIG. 22 illustrates a process of creating the VM guest 41 and setting a network used by the VM guest 41, the process being performed by the setting unit 15.

In step S121, the setting unit 15 receives, from the selection unit 14, a request to create the VM guest 41 and to set a network used by the VM guest 41 for a selected device.

In step S122, the setting unit 15 refers to VM creation information and acquires a network name used by the VM guest 41 newly set. The setting unit 15 also refers to a network setting information table and acquires information such as a VLAN identifier and a gateway used by a network having the network name. Then, the setting unit 15 sets a VLAN, a gateway, and so forth for the router 2 selected by the selection unit 14.

In step S123, the setting unit 15 transmits a request to create the VM guest 41 to the VM host 4.

In step S124, the setting unit 15 sets a default gateway to the VM guest 41 created in the VM host 4.

### Advantages and so Forth of this Embodiment

According to this embodiment, the analysis unit 13 of the management server 1 predicts changes in traffic volume in each router 2 not for each physical interface but for each logical interface corresponding to a physical interface. Then, the selection unit 14 adds up predicted values of logical interfaces to compute a predicted value of traffic volume of each router 2. This makes it possible to predict future changes in traffic volume more accurately for each router 2, which, in turn, makes it possible to suitably select the router 2 to which a new network is to be assigned.

Additionally, in this embodiment, the selection unit 14 selects the router 2 to which a new network is to be assigned, based on whether or not a total value obtained by adding a predicted value of traffic volume in a new logical interface to predicted values of traffic volume of the routers 2 has reached the tolerance L of traffic volume of the router 2. This may reduce the possibility that assignment of a new network will result in traffic volume exceeding the tolerance L in traffic volume of the router 2 to cause failure in a network.

More specifically, in this embodiment, the analysis unit 13 predicts, based on changes in actual values of the traffic information table 25, changes in the predicted value in traffic volume for each logical interface and changes in the predicted value in traffic volume for a logical interface used by a new network. Then, based on the prediction content, the selection unit 14 computes the predicted time period R taken until the traffic volume reaches the tolerance L, and, based on the predicted time period R, selects the router 2 to which the new network is to be assigned. Thus, for example, the router 2 in which it takes more time for the traffic volume to exceed the tolerance L may be selected.

Additionally, in this embodiment, when predicting the traffic volume in a logical interface used by a new network, the selection unit 14 acquires, for example, the largest amount among the largest increases in traffic volume for logical interfaces in a plurality of routers 2. Then, the selection unit 14 predicts that the traffic volume would change by an increase equal to the largest amount. In this way, in consideration of the possibility that the traffic volume would change while increasing most greatly, prediction is made and the router 2 is selected. This may more reduce the possibility that failure will occur after a network is added.

Furthermore, in this embodiment, prediction is made using a method that varies for each evaluation type in accordance with a change pattern in the actual value of traffic volume. This further improves prediction accuracy.

Specifically, in the case of the evaluation type A, the analysis unit 13 predicts that the predicted value of future traffic volume will change in a manner similar to the actual value of past traffic volume in the analysis unit time period M. Thus, for a logical interface for which traffic volume changes in a cycle similar to that of each analysis unit time period M, the traffic volume may be predicted accurately.

Additionally, in the case of the evaluation type B, the analysis unit 13 predicts traffic volume based on changes in the actual value of traffic volume in two analysis unit time periods. Thus, even when it is difficult to predict traffic volume compared with the case of the evaluation type A, a prediction reflecting actual values of traffic volume in a collective period in the past may be made. Note that two analysis unit time periods M (M1 and M2) are used in this embodiment; however, the number of the analysis unit time periods M used is not limited to two.

Furthermore, in this embodiment, in the case of the evaluation type C, it is predicted that traffic volume will change by the largest increase in the VLAN concerned. In this way, in consideration of the possibility that the traffic volume would change while increasing most greatly, prediction is made and the router 2 is selected. This may more reduce the possibility that failure will occur after a network is added.

Additionally, in this embodiment, changes in the actual value of traffic volume described above are specified by obtaining approximate expressions. Thus, even when the actual value varies to some extent, the determination of an evaluation type and the prediction described above may be made under the condition that the variation is absorbed. Note that, for example, in the case of the evaluation type A, when changes in actual value are equal among a plurality of analysis unit time periods, the actual values may be used directly as predicted values, without using prediction formulas, in computation of predicted values.

Here, in this embodiment, various types of requests are received from the administrator terminal 5; however, for example, various types of requests may be accepted through an input device or the like included in the management server 1.

Additionally, as described above, the techniques described in this embodiment are not limited to routers and may be applied to other network devices.

Furthermore, in this embodiment, description has been given using a VLAN connected to the VM guest 41, as an example of a logical network that uses a logical interface; however, the present disclosure is not limited to such an embodiment. Additionally, the case to which a method for predicting traffic volume of a network device in this embodiment is applied is not limited to that in which only a logical network is added, and this method may also be applied to the case in which a physical network itself is newly added.

Additionally, in this embodiment, each time the monitoring unit 12 acquires traffic information, a request to analyze traffic is transmitted to the analysis unit 13, and the analysis unit 13 performs a traffic analysis process. However, the analysis unit 13 may perform a traffic analysis process only when setting a new logical network (for example, when receiving a request to create a VM). In this case, for example, the receiving unit 11, upon receipt of a request for VM creation, transmits a request for traffic analysis to the analysis unit 13, and the analysis unit 13 performs a process of analyzing traffic and then may transmit, to the selection unit 14, a request to perform a process of selecting a network device.

### Second Embodiment

In a second embodiment, in addition to the techniques described in the first embodiment, the analysis unit time period M is made variable for every logical interface of a network device.

Typically, VM guests each perform customer business processing. Regarding customer business processing, the throughput sometimes changes in a certain cycle, and the transaction cycle sometimes varies for each VM guest. In other words, the cycle in which traffic volume changes varies for a VLAN used by each VM guest, that is, for each logical interface.

Here, as described in the above first embodiment, when, in a process of analyzing traffic volume, the traffic volume is classified as the evaluation type A, in which approximate expressions representing changes in traffic volume coincide with one another in all the analysis unit time periods M, it is possible to predict changes in traffic volume in the next analysis unit time period. Such a state in which traffic volume is classified as the evaluation type A is, that is, a state in which the analysis unit time period M coincides with a cycle in which traffic volume changes.

In view of this, in the second embodiment, the analysis unit time period M is set for each logical interface. For a logical interface for which traffic volume changes in a certain cycle, the analysis unit time period M is adjusted to be in accordance with the cycle to the extent possible. Thus, the number of logical interfaces for which the evaluation type A is determined, that is, the number of logical interfaces for which changes in traffic volume may be predicted accurately is increased.

Note that description of content similar to that in the first embodiment is, in principal, omitted. The functional configuration of the management server 1 is similar to that in the first embodiment and thus description thereof is omitted.

<Details of Data Configuration>

Data stored in the storage unit of the management server 1 in the second embodiment will be described. Here, only the basic definition information 21 and the evaluation information table 26, which differ in data configuration to those in the first embodiment, will be described.

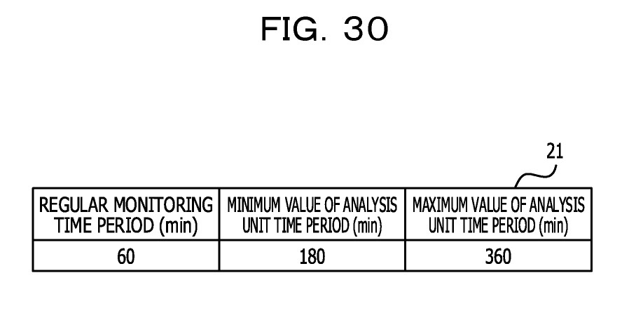

The basic definition information 21, which is basic information used for collection of traffic information and traffic analysis, includes the regular monitoring time period K (minute), and the minimum value (minute) of the analysis unit time period M and the maximum value (minute) of the analysis unit time period M for traffic evaluation as depicted in FIG. 30.

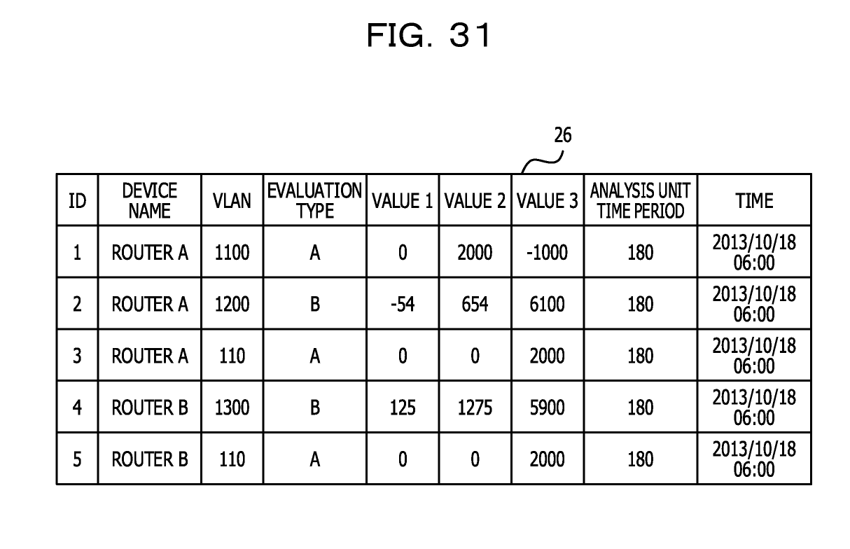

The evaluation information table 26 is a table in which results of analysis of traffic information performed by the analysis unit 13 are stored. The evaluation information table 26, as depicted in FIG. 31, includes items of a record ID, a device name, a VLAN identifier, an evaluation type, a value 1, a value 2, and a value 3 representing coefficients or the like of a prediction formula, and, for a logical interface used by a VLAN in question, an analysis unit time period and an analysis time at which an analysis result in question is identified. The value 1, the value 2, and the value 3 of the evaluation information table 26 are values corresponding to A, B, and C of the quadratic expression Y=Ax²+Bx+C, respectively, as in the first embodiment.

<Process Description>

In the second embodiment, the processes performed in the management server 1 will be described. Note that processes performed by the receiving unit 11, the monitoring unit 12, and the setting unit 15 are, in principal, similar to those in the first embodiment and redundant description thereof is omitted.

<Process Performed by Analysis Unit>

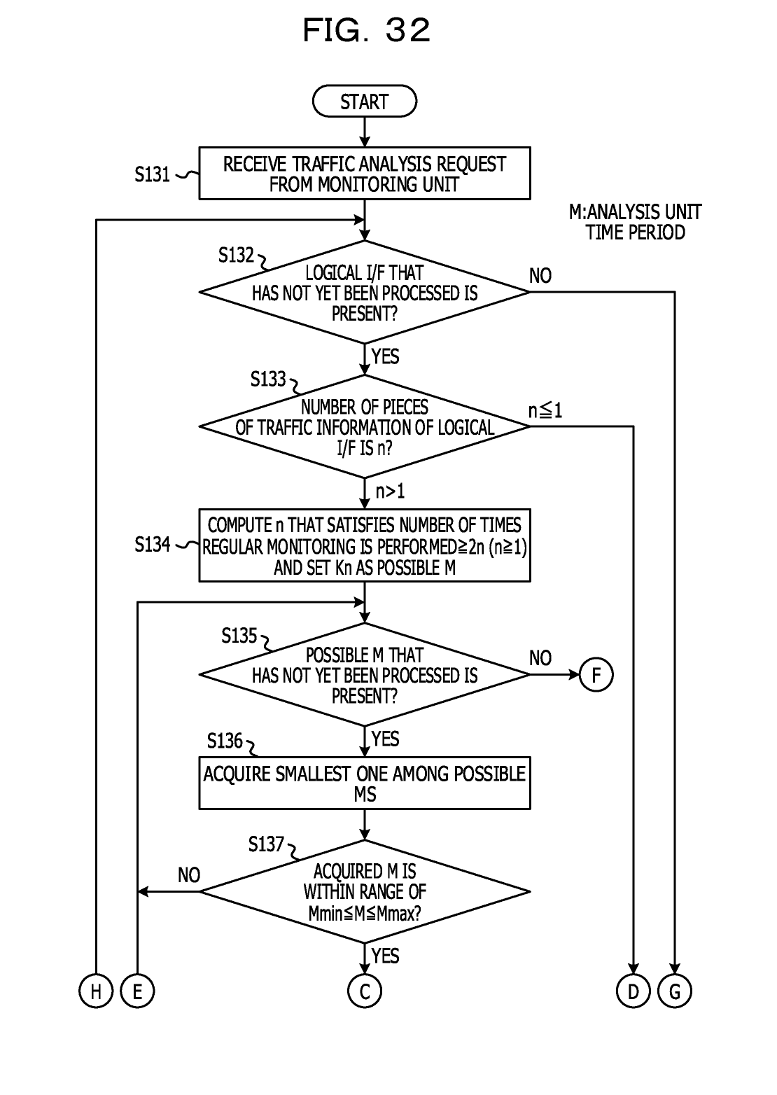

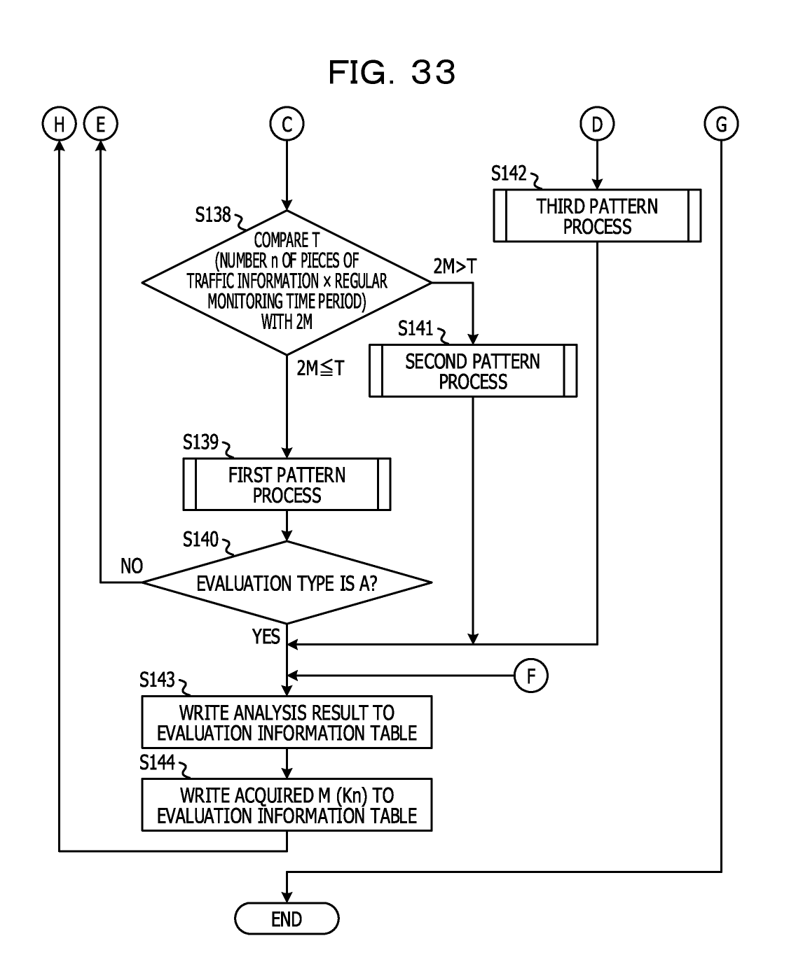

FIG. 32 and FIG. 33 are flowcharts illustrating an example of a traffic analysis process performed by the analysis unit 13 in the second embodiment.

In step S131, the analysis unit 13 receives, from the monitoring unit 12, a request to perform a process of analyzing traffic in the router 2 to be monitored.

In step S132, the analysis unit 13 refers to the device information table 22 and determines whether or not a logical interface that has not yet been processed is present. When the logical interface concerned is present (Yes), the analysis unit 13 proceeds to S133; when the logical interface concerned is not present (No), the analysis unit 13 completes the process.

In step S133, the analysis unit 13 refers to the device information table 22 and selects one logical interface to be analyzed. In other words, the analysis unit 13 selects one VLAN that uses one logical interface, from the device information table 22. Then, the analysis unit 13 refers to the traffic information table 25 and checks the number of pieces of traffic information of a logical interface used by the VLAN in question. When the number of pieces of traffic information is greater than one, that is, when it is possible to analyze traffic information (Yes), the analysis unit 13 proceeds to step S134. On the other hand, when the number of pieces of traffic information is less than or equal to one, that is, it is impossible to analyze traffic information (No), the analysis unit 13 proceeds to step S142.

In step S134, the analysis unit 13 computes one or a plurality of numbers n that satisfy conditions that the number of times regular monitoring is performed is less than or equal to 2n and n is one or more. Then, the analysis unit 13 sets a possible value of the analysis unit time period M to be a value (Kn) obtained by multiplying the regular monitoring time period K by n.

In step S135, the analysis unit 13 determines whether or not a possible value of the analysis unit time period M that has not yet been processed is present. When the possible value is present (Yes), the analysis unit 13 proceeds to step S136; when the possible value is not present (No), the analysis unit 13 proceeds to step S143.

In step S136, the analysis unit 13 acquires the smallest one among possible values of the analysis unit time period M.

In step S137, the analysis unit 13 refers to the basic definition information 21, and determines whether or not the analysis unit time period M acquired in step S136 is within a range greater than or equal to the minimum value of the analysis unit time period M and less than or equal to the maximum value of the analysis unit time period M. When the analysis unit time period M is within the range (Yes), the analysis unit 13 proceeds to step S138; when the analysis unit time period M is outside the range (No), the analysis unit 13 returns to step S135.

In step S138, the analysis unit 13 compares a value (T) with a value (2M) that is twice the possible value of the analysis unit time period M acquired in step S136. The value (T) is obtained by multiplying the number of pieces of traffic information of a logical interface used by a VLAN to be analyzed, which are registered in the traffic information table 25, by the regular monitoring time period K of the basic definition information 21. When T is greater than or equal to 2M, that is, when traffic information sufficient for analysis of traffic is obtained (Yes), the analysis unit 13 proceeds to step S140. When not, that is, when traffic information with which traffic analysis is possible but that is insufficient for traffic analysis is obtained (No), the analysis unit 13 proceeds to step S141.

In step S139, the analysis unit 13 performs the first pattern process.

In step S140, the analysis unit 13 determines whether or not the evaluation type is classified as A by using the first pattern process. When the evaluation type is A (Yes), the analysis unit 13 proceeds to step S143; when the evaluation type is not A (that is, in the case of B), the analysis unit 13 returns to step S135 in order to perform setting a more suitable analysis unit time period M.

In step S141, the analysis unit 13 performs the second pattern process.

In step S142, the analysis unit 13 performs the third pattern process.

In step S143, the analysis unit 13 registers, in the evaluation information table 26, a record indicating an analysis result for a VLAN that uses a logical interface being analyzed. Specifically, the analysis unit 13 newly assigns a record ID and registers a record in which an evaluation type decided based on a pattern process of any of step S138, step S141 and step S142, and the coefficient of the decided prediction formula and current time are associated with this record ID, the device name, and the VLAN identifier.

In step S144, the analysis unit 13 writes the analysis unit time period M acquired in step S136 to a record registered in step S143.

<Process Performed by Selection Unit>

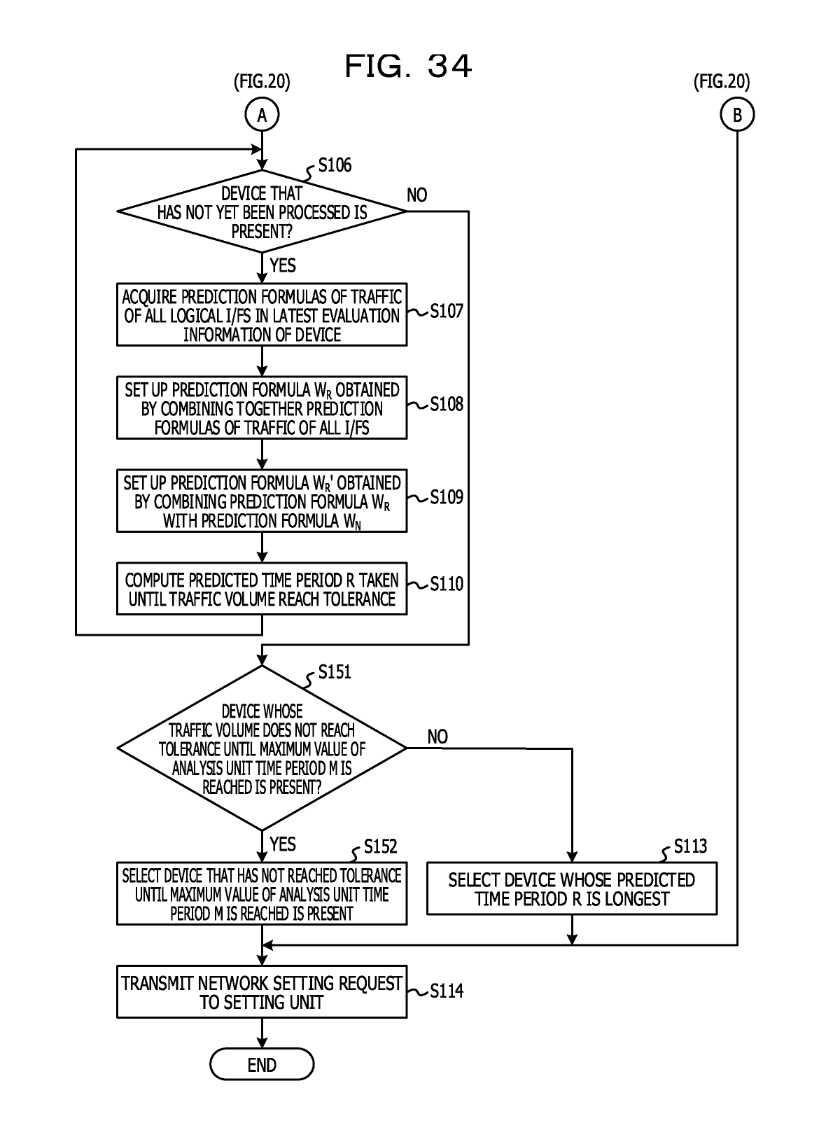

FIG. 34 illustrate part of a process of selecting a device to which a new logical interface is assigned, the process being performed by the selection unit 14 in the second embodiment. In the process of selecting a device, step S101 to step S105 illustrated in FIG. 20 in the first embodiment are not illustrated in the drawing and description thereof is omitted. The process of step S106 to step S110 and step 113 to step 114 illustrated in FIG. 34 is similar to that in the first embodiment and redundant description thereof is omitted.

In step S151, the selection unit 14 determines whether or not the router 2 whose traffic volume does not reach the tolerance L until the maximum value of the analysis unit time period M is reached is present. When the router 2 concerned is present (Yes), the selection unit 14 proceeds to step S152; when the router 2 concerned is not present (No), the selection unit 14 proceeds to steps S153.

In step S152, the selection unit 14 selects the router 2 whose traffic volume does not reach the tolerance L until the maximum value of the analysis unit time period M, as the router 2 to which a new logical interface is to be assigned.

### Advantages and so Forth of this Embodiment

According to the second embodiment, the following advantages are obtained in addition to the advantages of the first embodiment. That is, in the second embodiment, the duration of the analysis unit time period is variable for every logical interface, and the analysis unit 13 adjusts the analysis unit time period so that the evaluation type A is determined in the analysis process. This makes it possible to accurately predict changes in traffic volume for an increased number of logical interfaces for which traffic volume changes in a certain cycle.

Additionally, the analysis unit 13 adjusts the analysis unit time period mentioned above within a setting range between the maximum value and the minimum value set in advance in the basic definition information 21. This makes it possible to avoid a situation where the process of adjusting the analysis unit time period concerned is performed more than desired.

[Hardware Configuration and so Forth]

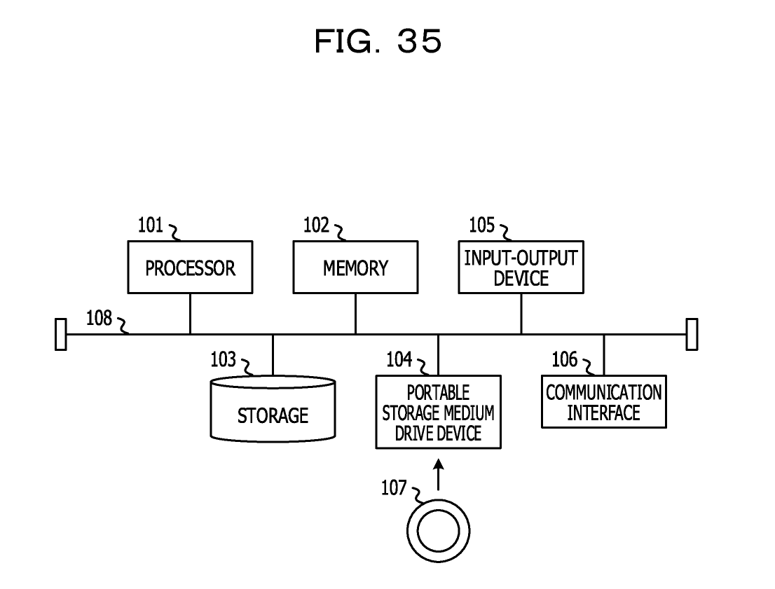

FIG. 35 illustrates an example of a hardware configuration of a computer functioning as the management server 1 described above. This computer includes a processor 101, a memory 102, a storage 103, a portable storage medium drive device 104, an input-output device 105, and a communication interface 106.

The processor 101 includes a control unit, an arithmetic unit, an instruction decoder, and the like, and an execution unit performs an arithmetic and logic operation in accordance with an instruction of a program read by the instruction decoder, in response to a control signal output from the control unit, and using the arithmetic unit. Such the processor 101 includes a control register in which various types of information used for control are stored, a cache that temporarily stores the content of the memory 2 or the like already accessed, and a translation lookaside buffer (TLB) having a function as a cache of a page table of virtual storage. Note that the processor 101 may have a configuration in which a plurality of central processing units (CPUs) are provided.

The memory 102 is a storage device, such as a random access memory (RAM), for example, and is a main memory to which a program executed by the processor 101 is loaded and in which data used for processing of the processor 101 is stored. The storage 103 is storage device, such as a hard disk drive (HDD) or a flash memory, for example, in which programs and various types of data are stored. The portable storage medium drive device 104 is a device that reads data and programs stored in a portable storage medium 107. The portable storage medium 107 is, for example, a magnetic disk, an optical disk, a magneto-optical disc, a flash memory, or the like. The processor 101, in cooperation with the memory 102 and the storage 103, executes programs stored in the storage 103 and the portable storage medium 107. Note that a program executed by the processor 101 and data to be accessed may be stored in another device communicable with the computer concerned. Note that the storage unit of the management server 1 described in the embodiments represents at least any of the memory 102, the storage 103, the portable storage medium 107, or another device communicable with the computer concerned.

The input-output device 105, being, for example, a keyboard, a touch panel, or a display, accepts an operation instruction by the user's operation or the like and outputs a result of processing performed by a computer.

The communication interface 106 may include, for example, in addition to, for example, a local area network (LAN) or the like, a wireless frequency receiver and a wireless frequency transmitter, and an optical receiver and an optical transmitter. The receivers and transmitters mentioned above may be implemented to be operable using one or a plurality of communication networks such as a Wi-Fi network, a blue-tooth network, and Long-term Evolution.

These components of the computer are coupled via a bus 108.

<Others>

It is noted that the function configuration and the physical configuration of a computer described herein are not limited to the forms described above. The functions and physical resources, for example, may be implemented in an integrated arrangement and, conversely, may be implemented in a more distributed arrangement.

Note also that, herein, the description portions “greater than or equal to” and “less than or equal to” in comparison with a threshold or the like are not limited to the description concerned unless otherwise noted, and may be suitably replaced with “greater than (exceed)” or “less than (fall below)”.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A management device comprising:
a memory; and
a processor coupled to the memory, configured to
acquire, from a plurality of network devices to be monitored, an actual value of past traffic volume for each of logical interfaces set on physical interfaces included in the network devices, and store the acquired actual value in a storage unit;
refer to the actual value of the traffic volume stored in the storage unit and, based on the actual value of the traffic volume, predict a future value of traffic volume for each of the logical interfaces; and
add up, for each of the plurality of network devices, the predicted value of traffic volume for each of the logical interfaces to compute a predicted value of traffic volume of each of the network devices, and, based on the predicted value of traffic volume of each of the network devices, select one of the network devices to which a new network is to be assigned.

2. The management device according to claim 1, wherein, based on whether or not a total value obtained by adding a predicted value of traffic volume for a logical interface used by the new network to the predicted value of traffic volume of each of the network devices computed reaches a tolerance of traffic volume in each of the network devices, the processor is configured to select one of the network devices to which the new network is to be assigned.

3. The management device according to claim 1,
wherein, based on changes in the actual value of the traffic volume, the processor is configured to predict changes in the predicted value of traffic volume for each of the logical interfaces and changes in a predicted value of traffic volume for a logical interface used by the new network, and
wherein, based on the changes in the predicted value of traffic volume for each of the logical interfaces and the changes in the predicted value of traffic volume for the logical interface used by the new network, the processor is configured to select one of the network devices to which the new network is to be assigned.

4. The management device according to claim 3, wherein, based on the changes in the predicted value of traffic volume for each of the logical interfaces and the changes in the predicted value of traffic volume for the logical interface used by the new network, the processor is configured to compute a time taken until a total value obtained by adding the predicted value of traffic volume for the logical interface used by the new network to the predicted value of traffic value of each of the network devices reaches a tolerance of traffic volume in each of the network devices, and, based on the time, select one of the network devices to which the new network is to be assigned.

5. The management device according to claim 3, wherein the processor is configured to acquire a largest amount among largest increases per given time period of the actual value of the traffic volume for each of the logical interfaces in the plurality of network devices, and predict that the predicted value of traffic volume for the logical interface used by the new network will change to increase by the largest amount per the given time period.

6. The management device according to claim 3, wherein the processor is configured to predict the changes in the predicted value of traffic volume for each of the logical interfaces by a method that varies in accordance with a change pattern in the actual value of the traffic volume in each given analysis unit time period.

7. The management device according to claim 6, wherein when changes in the actual value of the traffic volume in one of the analysis unit time periods coincides with or approximates changes in the actual value of the traffic volume in another one of the analysis unit time periods, the processor is configured to predict that the changes in the predicted value of traffic volume for each of the logical interfaces will coincide or approximate the changes in the actual value of the traffic volume.

8. The management device according to claim 7, wherein the processor is configured to specify an approximate expression representing changes in the actual value of the traffic volume in each of the analysis unit time periods and, when the approximate expression in one of the analysis unit time periods matches the approximate expression in another one of the analysis unit time periods, set the approximate expression as a prediction formula representing changes in predicted value of traffic volume for each of the logical interfaces.

9. The management device according to claim 6, wherein when changes in the actual value of the traffic volume in one of the analysis unit time periods does not coincide with or approximate changes in the actual value of the traffic volume in another one of the analysis unit time periods, the processor is configured to predict the changes in the predicted value of traffic volume for each of the logical interfaces, based on changes in the actual value of the traffic volume in a period including a plurality of the analysis unit time periods.

10. The management device according to claim 9, wherein the processor is configured to specify an approximate expression representing changes in the actual value of the traffic volume in each of the analysis unit time periods and, when the approximate expression in one of the analysis unit time periods does not match the approximate expression in another one of the analysis unit time periods, specify another approximate expression representing changes in the actual value of the traffic volume in a period including a plurality of the analysis unit time periods and set the other approximate expression as a prediction formula representing changes in the predicted value of traffic volume.

11. The management device according to claim 6, wherein when the changes in the predicted value of traffic volume for each of the logical interfaces are not capable of being specified, the processor is configured to acquire a largest increase in traffic volume per given period in the logical interface and predict that the predicted value of traffic volume for each of the logical interfaces will change to increase by the largest increase per the given time period.

12. The management device according to claim 6,
wherein a duration of the analysis unit time period is a duration that varies for each of the logical interfaces, and
wherein the processor is configured to specify, for a respective one of the logical interfaces, a duration of the analysis unit time period for which changes in the actual value of the traffic volume in one of the analysis unit time periods coincides with or approximates changes in the actual value of the traffic volume in another one of the analysis unit time periods, and decide upon the duration of the analysis unit time period as a duration of the analysis unit time period of the respective one of the logical interfaces.

13. The management device according to claim 12, wherein the processor is configured to set the duration of the analysis unit time period to be a duration included within a given setting range.

14. The management device according to claim 1, wherein the logical interfaces are assigned to a virtual network used by a virtual machine that operates on a device coupled to the network devices.

15. A machine readable medium storing a program that, when executed by a processor, causes the processor to perform operations comprising:
acquiring, from a plurality of network devices to be monitored, an actual value of past traffic volume for each of logical interfaces set on physical interfaces included in the network devices, and storing the acquired actual value in a storage unit;
referring to the actual value of the traffic volume stored in the storage unit and, based on the actual value of the traffic volume, predicting a future value of traffic volume for each of the logical interfaces; and
adding up, for each of the plurality of network devices, the predicted value of traffic volume for each of the logical interfaces to compute a predicted value of traffic volume of each of the network devices, and, based on the predicted value of traffic volume of each of the network devices, selecting one of the network devices to which a new network is to be assigned.

16. An information processing system comprising:
one or a plurality of information processing devices;
a plurality of network devices including physical interfaces at which logical interfaces assigned to a logical network connected to the information processing devices are set; and
a management device configured to monitor traffic volume in the network devices and assign the logical interfaces,
wherein the management device is configured to
acquire, from the plurality of network devices, an actual value of past traffic volume for each of the logical interfaces set on the physical interfaces included in the plurality of network devices, and store the acquired actual value in a storage unit,
refer to the actual value of the traffic volume stored in the storage unit and, based on the actual value of the traffic volume, predict a future value of traffic volume for each of the logical interfaces, and
add up, for each of the plurality of network devices, the predicted value of traffic volume for each of the logical interfaces to compute a predicted value of traffic volume of each of the network devices and, based on the predicted value of traffic volume of each of the network devices, select one of the network devices to which a new network is to be assigned.
